(19) United States
(12) Patent Application Publication
(10) Pub. No.: US 2010/0174456 A1
(43) Pub. Date: Jul. 8, 2010

(54) MECHANICAL CVT DRIVE TRAIN AND CONTROL METHOD FOR EARTH WORKING VEHICLE

(75) Inventors: Samuel Beaudoin, Mont-Saint-Hilaire (CA); Jean-Francois Doinne, St-Hubert (CA); Jean-Robert Desmeaules, Montreal (CA)

Correspondence Address: HUSCH BLACKWELL SANDERS LLP, 190 Carondelet Plaza, Suite 600, ST. LOUIS, MO, 63105, US

(73) Assignee: S.O.E. TECHNOLOGIES INC., Ste-Julie, QC (CA)

(21) Appl. No.: 12/438,400

(22) PCT Filed: Aug. 23, 2007
(86) PCT No.: PCT/CA2007/001478

§ 371 Date: Dec. 16, 2009

Related U.S. Application Data
(60) Provisional application No. 60/823,361, filed on Aug. 23, 2006.

(51) Int. Cl. G06F 19/00; B60K 17/08

(52) U.S. Cl. 701/51; 180/364

(57) ABSTRACT

An earth working vehicle which has an internal combustion engine and a driveline for establishing a driving relationship between the internal combustion engine and wheels of the earth working vehicle. The driveline includes a mechanical CVT. The earth working vehicle also has a control for manual operation by a driver of the earth working vehicle, the control operable by the driver to select among at least two modes of operation, namely a first mode of operation and a second mode of operation, the selection of the first mode of operation corresponding to a command to cause the vehicle to move forward, the selection of the second mode of operation corresponding to a command to cause the vehicle to move backwards. The earth moving vehicle also has an electronic controller. While the vehicle is in motion, the electronic controller is responsive to a change of a mode of operation made via the control and indicating a command to reverse a direction of travel of the vehicle, to issue a control signal to the mechanical CVT to cause the mechanical CVT to downshift.

### CROSS-REFERENCE TO RELATED APPLICATION

The present application claims the benefit under 35 USC §119(e) of prior U.S. provisional patent application Ser. No. 60/823,361 to Beaudoin, filed Aug. 23, 2006, hereby incorporated by reference herein.

### FIELD OF THE INVENTION

The present invention generally relates to mechanical transmission systems in earth working vehicles. More specifically, the present invention is concerned with a Continuously Variable Transmission (CVT) system that can be advantageously used in an earth working vehicle such as agricultural, industrial or construction equipment to improve the drivability and the general usefulness of the vehicle.

### BACKGROUND

Traditionally, earth working vehicles have been designed using multiple ratio geared transmissions such as the one described in the U.S. Pat. No. 5,063,793. As the need for versatility increased, transmissions were provided with greater numbers of gear ratios. To increase drivability, transmission shifting was automated with hydraulic clutches controlled by a complex combination of hydraulic circuits and electronic controllers as shown in U.S. Pat. No. 4,991,454. Recently, hydrostatic type continuously variable transmissions (CVTs) were introduced. These mechanical CVTs allow a virtually infinite number of ratios between a minimum and a maximum ratio. Since there is no discontinuity in the ratio change, these transmissions are smoother and because of the wide ratio range, control methods were developed to improve vehicle productivity and fuel economy.

However, the main problem with existing hydrostatic mechanical CVTs is their lack of reliability. For example, it is known in the industry that these mechanical CVTs are affected significantly by temperature variations which affect oil viscosity, causing overheat or over-pressure operation within the hydrostatic variator.

Another problem with existing mechanical CVTs is the creation of a power loop in the mechanical CVT variator which drastically increases the load carried by the mechanical CVT system. The power loops so created multiply the power losses in the mechanical CVT and require a mechanical CVT design that can carry out the additional power in the loop. This is expensive and complex.

### SUMMARY OF THE INVENTION

The present invention relates to an earth working vehicle and components thereof that uses a mechanical CVT to transmit power from the internal combustion engine to the wheels of the vehicle. A mechanical CVT is a transmission where the ratio of the rotational speeds of the input and output shafts can be continuously varied (within a certain range) to provide within that range a virtually infinite number of possible transmission ratios.

For the purpose of this specification, “earth working vehicle” refers to an industrial vehicle that is intended to be used in agricultural, construction, snow clearing or mining operations. These vehicles are primarily off-road vehicles and travel at slow speeds. Non-limiting examples of earth working vehicles include:

Backhoe loaders;

Forest machines;

Hydraulic excavators;

Industrial loaders;

Material handlers;

Motor graders;

Skid steer loaders;

Track loaders;

Underground mining machines;

Tractors; and

Harvesters.

Also, for the purpose of this specification “mechanical CVT” refers to a continuously variable transmission where power is transferred and ratio change is effected by using mechanical components. An example of a mechanical CVT is described in the International patent application WO 2006/034582 filed in the name of SOE Technologies Inc. This mechanical CVT is of the traction roller type. Other types of mechanical CVTs may also be suitable, including but not limited to Van Dorn transmissions.

More specifically, the invention provides in one broad aspect an earth working vehicle which has an internal combustion engine and a driveline for establishing a driving relationship between the internal combustion engine and wheels of the earth working vehicle. The driveline includes a mechanical CVT. The earth working vehicle also has a control for manual operation by a driver of the earth working vehicle, the control operable by the driver to select among at least two modes of operation, namely a first mode of operation and a second mode of operation, the selection of the first mode of operation corresponding to a command to cause the vehicle to move forward, the selection of the second mode of operation corresponding to a command to cause the vehicle to move backwards. The earth moving vehicle also has an electronic controller. While the vehicle is in motion, the electronic controller is responsive to a change of a mode of operation made via the control and indicating a command to reverse a direction of travel of the vehicle, to issue a control signal to the mechanical CVT to cause the mechanical CVT to downshift.

In another broad aspect the invention also provides an earth working vehicle which has an internal combustion engine and a driveline for establishing a driving relationship between the internal combustion engine and wheels of the earth working vehicle. The driveline includes a mechanical CVT, a movement reversal assembly operable to reverse a direction of travel of the vehicle and a coupling that can be disengaged by the driver. When the coupling is disengaged, the driveline ceases to transmit power from the internal combustion engine to the wheels of the vehicle. The vehicle also has a control for manual operation by a driver of the earth working vehicle, the control operable by the driver to select among at least two modes of operation, namely a first mode of operation and a second mode of operation, the selection of the first mode of operation corresponding to a command to cause the vehicle to move forward, the selection of the second mode of operation corresponding to a command to cause the vehicle to move backwards. The earth moving vehicle also has an electronic controller. While the vehicle is in motion, the electronic controller is responsive to a change of a mode of operation made via the control indicating a command to reverse a direction of travel of the vehicle to issue control signals to the mechanical CVT and to the movement reversal assembly to change an operating condition of the mechanical CVT and of the movement reversal assembly such as to change a direction of travel of the vehicle without the necessity that the driver disengages the coupling in the driveline.

In another broad aspect the invention also provides an earth working vehicle which has which has an internal combustion engine and a driveline for establishing a driving relationship between the internal combustion engine and wheels of the earth working vehicle. The driveline includes a mechanical CVT and a movement reversal assembly operable to reverse a direction of travel of the vehicle. The earth working vehicle has brakes operable by the driver to stop the vehicle. Also the earth working vehicle has a control for manual operation by the driver of the earth working vehicle, the control operable by the driver to select among at least two modes of operation, namely a first mode of operation and a second mode of operation, the selection of the first mode of operation corresponding to a command to cause the vehicle to move forward, the selection of the second mode of operation corresponding to a command to cause the vehicle to move backwards. The vehicle also has an electronic controller, while the vehicle is in motion, the electronic controller being responsive to a change of mode of operation made via the control indicating a command of the driver to reverse a direction of travel of the vehicle to issue control signals to the mechanical CVT and to the movement reversal assembly to change an operating condition of the mechanical CVT and of the movement reversal assembly such as to change a direction of travel of the vehicle without the necessity that the driver operates the brakes of the vehicle.

In another broad aspect the invention also provides an earth working vehicle which has which has an internal combustion engine and a driveline for establishing a driving relationship between the internal combustion engine and wheels of the earth working vehicle. The driveline includes a mechanical CVT. The earth working vehicle has an accelerator for operation by a driver of the vehicle and a mode selection control for operation by the driver, the mode selection control allowing the accelerator to acquire at least two operative modes, namely a first mode of operation in which the accelerator controls a fuel supply assembly of the internal combustion engine and a second mode of operation in which the accelerator controls a speed at which the vehicle travels, the accelerator outputting a signal conveying information on the position acquired by the accelerator when operated by the driver. The earth working vehicle also has an electronic controller. When the mode selection control places the accelerator in the first operative mode the electronic controller is responsive to the signal conveying information on the position of the accelerator to issue a control signal to a fuel supply assembly of the internal combustion engine. When the mode selection control places the accelerator in the second operative mode the electronic controller is responsive to the signal conveying information on the position of the accelerator to issue a control signal to the mechanical CVT to regulate a ratio of the mechanical CVT to cause the vehicle to travel at a speed indicated by the position of the accelerator.

In another broad aspect the invention also provides an earth working vehicle which has which has an internal combustion engine and a driveline for establishing a driving relationship between the internal combustion engine and wheels of the earth working vehicle. The driveline includes a mechanical CVT. The earth working vehicle has an accelerator for operation by a driver of the vehicle. The earth working vehicle also has an electronic controller. The electronic controller operative to issue a control signal to the mechanical CVT to regulate a ratio of the mechanical CVT to cause the vehicle to travel at a speed indicated by the position of the accelerator.

In another broad aspect the invention also provides an earth working vehicle having an internal combustion engine with a fuel supply assembly. The vehicle also has a driveline for establishing a driving relationship between the internal combustion engine and wheels of the earth working vehicle. The driveline includes a mechanical CVT. The vehicle also has an electronic controller for regulating the fuel supply assembly and a ratio of the mechanical CVT to vary the amount of power produced by the internal combustion engine while maintaining an RPM of the internal combustion engine at a set value.

In another broad aspect the invention also provides an earth working vehicle that has an internal combustion engine and a driveline for establishing a driving relationship between the internal combustion engine and wheels of the earth working vehicle. The driveline has a mechanical CVT. The earth working vehicle has a continuously variable control for manual operation by a driver of the earth working vehicle to adjust a ratio of the mechanical CVT and an electronic controller responsive to a signal produced by the control and indicative of a position imparted by the driver to the control to generate a control signal to the mechanical CVT to cause the mechanical CVT to acquire a ratio corresponding to the position of the control.

In another broad aspect the invention also provides an earth working vehicle that has an internal combustion engine and a driveline for establishing a driving relationship between the internal combustion engine and wheels of the earth working vehicle. The driveline has a mechanical CVT. The earth working vehicle also has a sensor for generating a signal conveying a true ground speed information of the vehicle and an electronic controller for receiving the signal and using the true ground speed information to generate a control signal for adjusting the ratio of the mechanical CVT to maintain the true ground speed of the vehicle at a set level.

In another broad aspect the invention also provides an earth working vehicle that has an internal combustion engine and a driveline for establishing a driving relationship between the internal combustion engine and wheels of the earth working vehicle. The driveline has a mechanical CVT. The driveline including a gearbox downstream the mechanical CVT in a direction of power flow through the driveline from the internal combustion engine to the wheels of the vehicle, the gearbox being shiftable from a first ratio to a second ratio to provide downstream of the gearbox two output torque ranges associated with the first and second ratios, respectively.

In another broad aspect the invention provides a driveline unit for use in an earth working vehicle that establishes a driving relationship between an internal combustion engine and wheels of the earth working vehicle. The driveline unit has a mechanical CVT having operating components that include a plurality of traction rollers in rolling engagement with respective races. The driveline also includes a gearbox having mechanical gears configured to transmit power produced by the internal combustion engine to the wheels of the vehicle and a lubrication system configured to supply lubricant from a common supply to the contact surfaces between the traction rollers and the respective races and to the gears of the gearbox.

In another broad aspect the invention provides a driveline unit for use in an earth working vehicle that establishes a driving relationship between an internal combustion engine and wheels of the earth working vehicle. The driveline unit has a mechanical CVT having operating components that include a plurality of traction rollers in rolling engagement with respective races. The driveline also includes a gearbox having mechanical gears configured to transmit power produced by the internal combustion engine to the wheels of the vehicle and a dual lubrication system configured to supply lubricant from a first supply to contact surfaces between the traction rollers and the respective races and supply lubricant from a second supply to the gears of the gearbox, the first and second supplies being isolated from one another to prevent the exchange of lubricant between the first and second supplies.

In another broad aspect the invention provides a driveline unit for use in an earth working vehicle that establishes a driving relationship between an internal combustion engine and wheels of the earth working vehicle. The driveline has a traction roller mechanical CVT including operating components, a gearbox including mechanical gears configured to transmit power produced by the internal combustion engine to the wheels of the vehicle and a lubrication system. The lubrication system has a pump configured to circulate lubricant among the operating components of the mechanical CVT and a lubricant filter through which lubricant supplied by the pump flows.

In another broad aspect the invention provides a driveline unit for use in an earth working vehicle that establishes a driving relationship between an internal combustion engine and wheels of the earth working vehicle. The driveline has a traction roller mechanical CVT including operating components, a gearbox including mechanical gears configured to transmit power produced by the internal combustion engine to the wheels of the vehicle. The driveline unit has a lubrication system defining a lubrication circuit that includes a supply of lubricant. A pump is configured to flow lubricant from the lubricant supply along the lubrication circuit to supply lubricant to the operating components of the mechanical CVT. A lubricant level sensor in the lubrication circuit is provided to detect a low lubricant level condition and issue a signal conveying the low lubricant level condition.

In another broad aspect the invention provides a driveline unit for use in an earth working vehicle that establishes a driving relationship between an internal combustion engine and wheels of the earth working vehicle. The driveline has a traction roller mechanical CVT including operating components, a gearbox including mechanical gears configured to transmit power produced by the internal combustion engine to the wheels of the vehicle. The driveline unit has a lubrication system defining a lubrication circuit that includes a supply of lubricant. A pump is configured to flow lubricant from the lubricant supply along the lubrication circuit to supply lubricant to the operating components of the mechanical CVT. A temperature sensor is provided in the lubrication circuit to detect a high temperature lubricant condition and issue a signal conveying the high temperature lubricant condition.

In another broad aspect the invention also provides an earth working vehicle that has an internal combustion engine and a driveline for establishing a driving relationship between the internal combustion engine and wheels of the earth working vehicle. The driveline has a traction roller mechanical CVT including operating components enclosed by a casing, the mechanical CVT configured to transfer power received from an input shaft to an output shaft. The driveline has a gearbox including mechanical gears configured to transmit power from the internal combustion engine to the wheels of the vehicle. The casing of the mechanical CVT including at least two parts that mate along a plane that is perpendicular to the axis of the input shaft and the axis of the output shaft.

In another broad aspect the invention provides an earth working vehicle for powering an earth working implement. The earth working vehicle has an internal combustion engine and a driveline for establishing a driving relationship between the internal combustion engine and wheels of the earth working vehicle. The driveline includes a mechanical CVT. The earth working vehicle has an earth working implement control for selectively establishing or terminating a power flow from the vehicle to the earth working implement. The earth working vehicle also has a speed control system including a selector operable by a driver of the vehicle, the selector allowing the driver to select between at least two modes of operation, namely a first mode of operation and a second mode of operation, the speed control system:
i. in the first mode of operation issuing control signals to the mechanical CVT and to a fuel supply assembly of the internal combustion engine to vary a ratio of the mechanical CVT and an amount of power produced by the internal combustion engine to maintain a speed of the vehicle at a preset value while the earth working implement control establishes a power flow from the vehicle to the earth working implement;
ii. in response to a switch from the first mode of operation to the second mode of operation issuing a control signal to the earth working implement control for temporarily terminating a power flow from the vehicle to the earth working implement;
iii. in response to a switch back to the first mode from the second mode, issuing a control signal to the earth working implement to re-establish a power flow from the vehicle to the earth working implement and continue issuing control signals to the mechanical CVT and to the fuel supply assembly of the internal combustion engine to vary a ratio of the mechanical CVT and an amount of power produced by the internal combustion engine to maintain a speed of the vehicle at the preset value.

In another broad aspect the invention provides an earth working vehicle. The earth working vehicle has an internal combustion engine and a driveline for establishing a driving relationship between the internal combustion engine and wheels of the earth working vehicle. The driveline includes a mechanical CVT. The earth working vehicle also has a speed control system including a selector operable by a driver of the vehicle, the selector allowing the driver to select between at least two modes of operation, namely a first mode of operation and a second mode of operation, the speed control system:
i. in the first mode of operation issuing control signals to the mechanical CVT and to a fuel supply assembly of the internal combustion engine to vary a ratio of the mechanical CVT and an amount of power produced by the internal combustion engine to maintain a speed of the vehicle at a fixed value;
ii. in response to a switch from the first mode of operation to the second mode of operation, issuing control signals to the mechanical CVT and to a fuel supply assembly of the internal combustion engine to vary a ratio of the mechanical CVT and an amount of power produced by the internal combustion engine to maintain a speed of the vehicle at a speed in dependence upon driver actuation of an accelerator pedal;
iii. in response to a switch back to the first mode from the second mode, re-issuing control signals to the mechanical CVT and to the fuel supply assembly of the internal combustion engine to vary a ratio of the mechanical CVT and an amount of power produced by the internal combustion engine to maintain the speed of the vehicle at the fixed value.

In another broad aspect the invention provides an earth working vehicle having an internal combustion engine and a driveline for establishing a driving relationship between the internal combustion engine and wheels of the earth working vehicle. The driveline includes a mechanical CVT. The earth working vehicle also has an electronic controller responsive to a shutdown command of the internal combustion engine to issue a control signal to the mechanical CVT to cause the mechanical CVT to downshift.

In another broad aspect the invention provides an earth working vehicle having an internal combustion engine and a driveline for establishing a driving relationship between the internal combustion engine and wheels of the earth working vehicle. The driveline includes a mechanical CVT and a gearbox downstream the mechanical CVT. The gearbox has a forward movement assembly and a reverse movement assembly. The mechanical CVT rotates in the same direction irrespective of whether the forward movement assembly is operated to drive the earth moving vehicle forward or the reverse movement assembly is operated to drive the earth moving vehicle in a reverse direction.

### BRIEF DESCRIPTION OF THE DRAWINGS

FIG. 1 is a schematical view of a driveline unit of an earth working vehicle in the form of a tractor for agricultural applications, according to a non-limiting example of implementation of the invention;

FIG. 2 is a block diagram of various functional components of the earth working vehicle, including an electronic controller used to provide different functionalities;

FIG. 3 is a flowchart of a process implemented by the electronic controller shown in FIG. 2 to change the direction of travel of the earth moving vehicle;

FIG. 4 is a flowchart of a process implemented by the electronic controller shown in FIG. 2 where the position of the accelerator determines the travel speed of the earth working vehicle;

FIG. 5 is a flowchart of a process implemented by the electronic controller shown in FIG. 2 where the position of the accelerator determines the travel speed of the earth working vehicle, but where the engine speed is kept constant to drive an earth working implement;

FIG. 6 is a flowchart of a process implemented by the electronic controller shown in FIG. 2, where the engine speed is determined by the position of the accelerator;

FIG. 7 is a block diagram similar to that of FIG. 2, further including a headland turn sequence (HTS) interface;

FIGS. 8A to 8D are different views of the drive train unit showing the casing of the drivetrain unit;

FIG. 9 is a longitudinal cross-sectional view of a toroidal continuously variable transmission;

FIG. 10a is a radial cross-sectional view of a ratio control assembly of the transmission shown in FIG. 9;

FIG. 10b is a cross-sectional view of the assembly of FIG. 10a taken from line BB;

FIG. 11a is a side view of the ratio control assembly of FIG. 10a showing an actuating mechanism;

FIG. 11b is a partial top view of the actuating mechanism of FIG. 11a;

FIG. 12a is a top view of one roller assembly of the transmission of FIG. 9 for a minimum underdrive ratio;

FIG. 12b is a top view of the assembly of FIG. 12a at a constant ratio of 1;

FIG. 12c is a top view of the assembly of FIG. 12a for a maximum overdrive ratio; and

FIG. 13 is a block diagram similar to that of FIG. 2, in accordance with a variant.

### DETAILED DESCRIPTION OF EMBODIMENTS

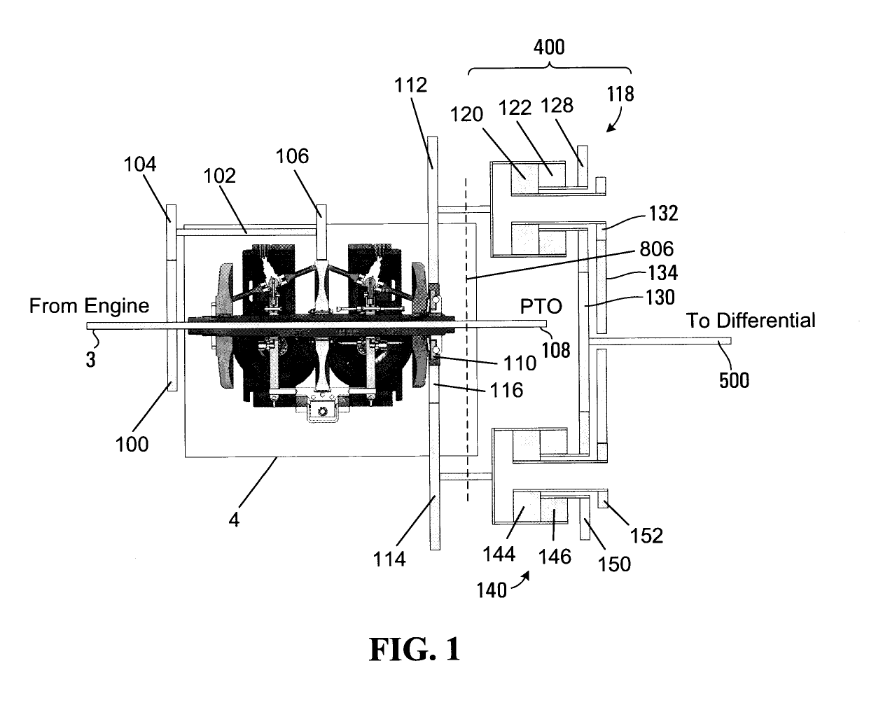

An embodiment of the driveline unit of an earth working vehicle, such as a tractor, is shown on FIG. 1. The driveline unit allows rotary movement to be communicated from the internal combustion engine to the wheels of the vehicle and optionally to a Power Take Off (PTO) 108. An input shaft 3 is connected directly with the engine. A main gear 100 is keyed to the main shaft 3 and rotates therewith. The main gear 100 drives a secondary shaft 102 via gear 104 that meshes with main gear 100. The secondary shaft 102 brings power to the mechanical CVT 4 via gear 106 that drives the input rotary disk of the mechanical CVT 4. The input shaft 3 extends through the entire mechanical CVT 4 and leads to the PTO 108 such as to drive the PTO 108. The input shaft 3 coinciding with the rotation axis of the main disks of the mechanical CVT 4 (the main disks and the other components of the mechanical CVT 4 will be described later).

While not shown in the drawings, a main coupling device can be placed on the input shaft 3 such that when the main coupling device is disengaged the internal combustion engine would be allowed to spin freely or somewhat independently of the mechanical CVT 4. In contrast, when the coupling device is engaged rotary movement is passed from the internal combustion engine to the mechanical CVT 4. In the specific example the coupling device is in the form of a clutch. The clutch can be directly connected by a mechanical/hydraulic link to the operator clutch pedal or the pedal may be connected to a potentiometer sending a signal to the vehicle electronic controller that drives an actuator on the main clutch that moves proportionally with the operator clutch pedal. In a possible variant, the main coupling device can be in the form of a torque converter when the work vehicle needs to produce high torque at low speed such as in the case of earth moving equipment.

The mechanical CVT 4 has an output gear 110 that drives a gearbox 400 which links the mechanical CVT 4 to the output shaft 500 that is connected to the differential of the earth working vehicle (e.g., tractor) and ultimately the wheels. The gearbox 400 has a forward gear 112 and a motion reversal assembly including a pair of reverse gears 114 and 116. The purpose of the pair of reverse gears 114, 116 is to obtain a reverse direction of rotation with relation to the forward gear 112. The reverse direction of rotation is used when the earth working vehicle (e.g., tractor) is to travel in a reverse direction.

The forward gear drives a high speed/low speed selector box 118. The high speed/low speed selector box includes a coupling device. The coupling device has two couplings in the form of clutches. Alternatively, torque converters can be used instead of clutches. The first clutch 120 is the low speed clutch while the second clutch 122 is the high speed clutch. The clutches 120 and 122 are preferably incorporated in one electro-hydraulically actuated powershift clutches also known in the industry as a drum pack. (A suitable non-limiting example of an electro-hydraulically actuated powershift clutch is described is U.S. Pat. No. 5,450,768) Applying the hydraulic pressure on one side of the drum pack will engage one clutch let's say the low speed clutch 120 while applying the hydraulic pressure on the other side of the drum pack will engage the second clutch in this case the high speed clutch 122. It is to be noted that if no hydraulic pressure is applied on the drum pack both clutches 120, 122 are disengages thus the forward gear 112 is spinning freely.

When the high speed clutch 122 is selected the gear 128 that is connected to high speed clutch 122, will drive first output gear 130 that in turn drives the differential and in turn the wheels. On the other hand, when low speed clutch 120 is engaged it drives a second output gear 134 via a gear 132, but at a slower speed (higher torque) than when the high speed clutch 122. Either one of the first and second gears 130, 134 can drive the differential. The selection of the output gear 130, 134 that will drive the differential is made via a synchronizer.

In a similar fashion, the reverse gear 114 drives a high speed/low speed selector box 140. The high speed/low speed selector box 140 includes a coupling device with a high speed and low speed clutches 146 and 144 that drive the output gears 130 and 134 via the gears 150 and 152, respectively.

The cabin of the earth working vehicle (e.g., tractor) has a set of controls that allow the driver to operate the selector boxes 118 and 140 in order to control the in-gear or out of gear status, the direction of travel of the earth working vehicle (e.g., tractor) and whether the high speed or the low speed gear is being selected.

This set of controls (not shown in the drawings) include a clutch pedal that determines if anyone of the clutches 120, 122, 144 and 146 that is designated as the active clutch, is engaged or disengaged. The clutch pedal operates in a traditional fashion in that when depressed, the active clutch is disengaged and when the pedal is at rest or fully released the clutch is engaged.

Another control in the set of controls determines the direction of movement of the earth working vehicle (e.g., tractor). This forward/reverse control can be placed in any appropriate location reachable by the driver. It can be a pedal, a lever a button or operable via a user interface if a computerized control system is used. In one example of implementation, the directional control has only two possible operative states, one state corresponding to a forward movement and one state corresponding to a reverse movement.

The set of controls also has a high/low speed selector which determines if anyone of the high speed clutches 122, 146 or the low speed clutches 120, 144 will be engaged, such as to determine if the earth working vehicle (e.g., tractor) operates within the high speed range or within the low speed range of the drive train unit. Similar to the forward/reverse control the high/low speed selector can be a pedal, a lever a button or operable via a user interface if a computerized control system is used.

The clutch pedal operates anyone of the clutches 120, 122, 144 or 146 that is designated as the active clutch, hydraulically. The clutch that is designated as the “active” one will be determined by the position of the forward/reverse control and by the position of the high/low speed selector. More specifically, the forward/reverse control and the high/low speed selector are in the form of valves (or indirectly operate valves) in a hydraulic circuit such as to route hydraulic pressure to anyone of the clutches 120, 122, 144 or 146.

If the clutch pedal is fully released no hydraulic pressure is supplied to anyone of the clutches 120, 122, 144 or 146 irrespective of the position of the forward/reverse control and the high/low speed selector. Therefore, both selector boxes 118 and 140 spin freely, in other words no power is being transmitted to the differential.

When the forward/reverse control is put to the forward position and the high/low speed selector is put in the high speed position, then clutch 122 becomes active and then hydraulic pressure will be directed to the clutch 122 if the clutch pedal is released. Also, the synchronizer 136 is operated such that power to the differential is delivered via the output gear 130.

When the forward/reverse control is put to the forward position and the high/low speed selector is put in the low speed position, then clutch 120 becomes active and then hydraulic pressure will be directed to the clutch 120 if the clutch pedal is released. Also, the synchronizer 136 is operated such that power to the differential is delivered via the output gear 134.

When the forward/reverse control is put to the reverse position and the high/low speed selector is put in the high speed position, then clutch 146 becomes active and then hydraulic pressure will be directed to the clutch 146 if the clutch pedal is released. Also, the synchronizer 136 is operated such that power to the differential is delivered via the output gear 130.

When the forward/reverse control is put to the reverse position and the high/low speed selector is put in the low speed position, then clutch 144 becomes active and then hydraulic pressure will be directed to the clutch 144 if the clutch pedal is released. Also, the synchronizer 136 is operated such that power to the differential is delivered via the output gear 134.

Note that irrespective of whether the power is transmitted to the wheels via the selector box 118 which drives the earth moving vehicle forward, or the selector box 140 which drives the earth moving vehicle in a reverse direction, the mechanical CVT 4 rotates in the same direction. Specifically, the shaft 3 turns in the same direction all the time irrespective of whether the earth moving vehicle travels forward or backwards.

While not shown in the drawings, power flow to the PTO gear system is controlled by the PTO coupling in the form of a clutch that connects the input shaft 3 to the PTO system input shaft.

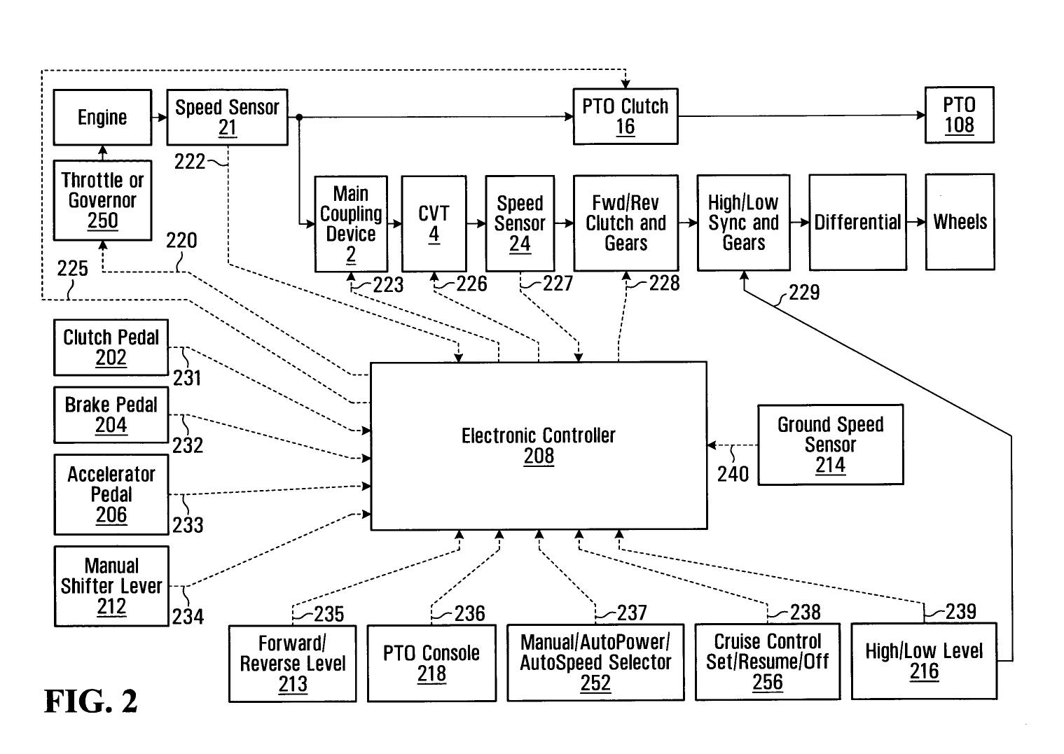

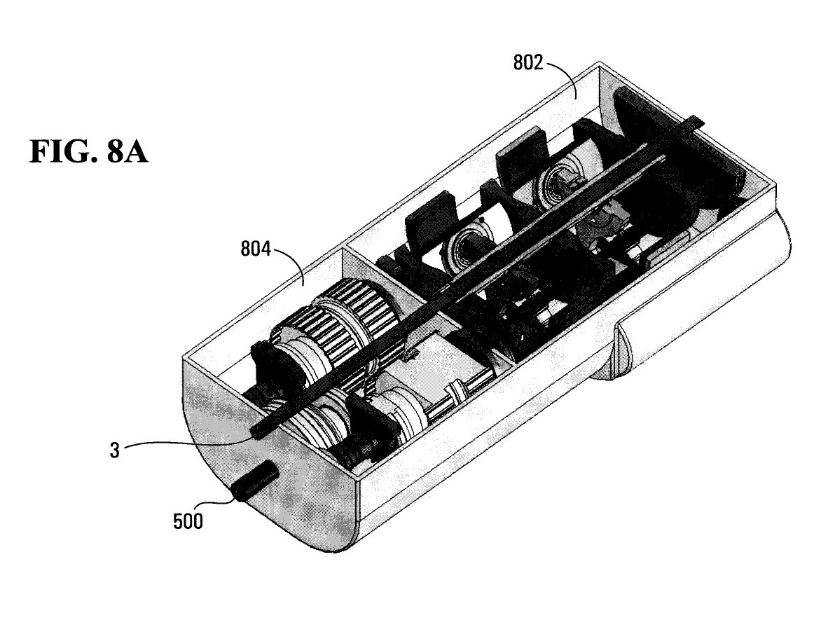

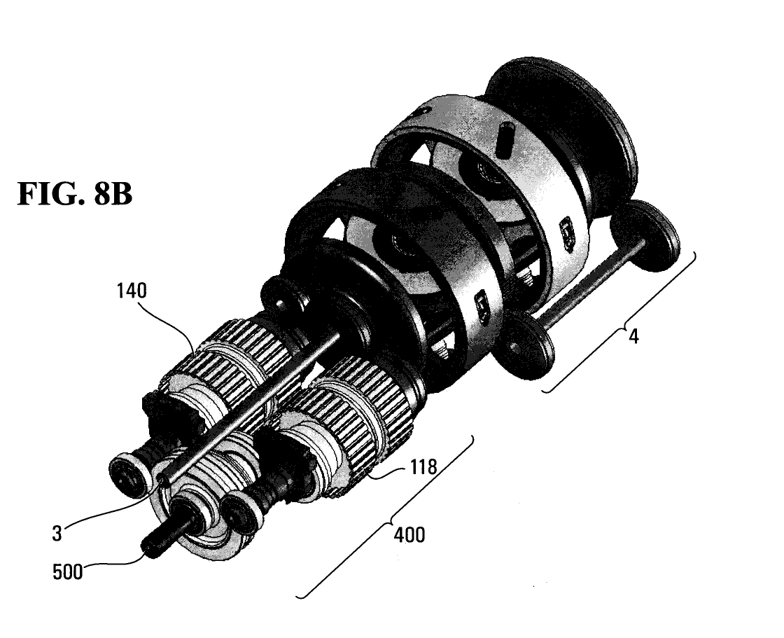

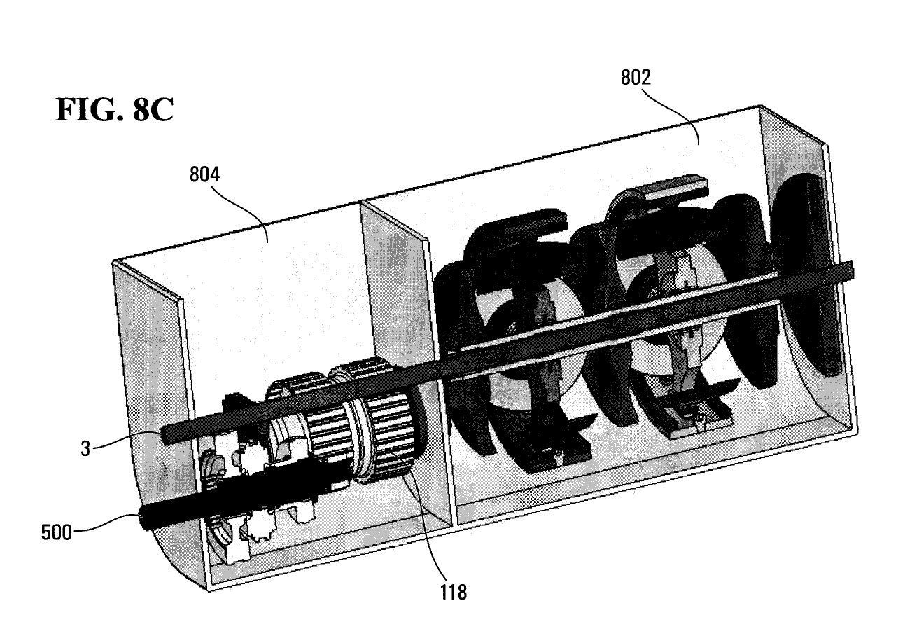

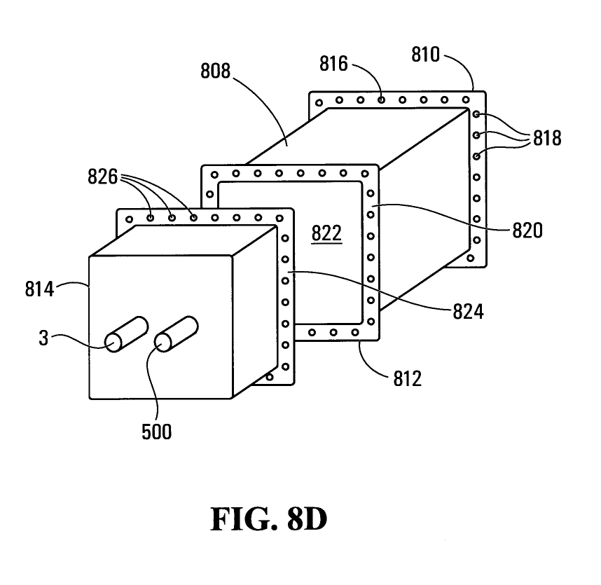

FIGS. 8A through 8D illustrate the components of the drivetrain unit mounted in a suitable casing. Generally speaking, the casing defines two separate compartments, namely 802 and 804 in which are placed the mechanical CVT 4 and the gearbox 400, respectively. More specifically, the compartment 804 holds all the components of the drive train unit that are located on the right of the reference line 806 appearing in FIG. 2. Note that while the drawings in FIGS. 8A and 8B show the casing split longitudinally along the axis of the shaft 3, this is for illustration only. FIG. 8D is the exploded assembly view of the drive train unit where the different casing sections are shown separated from one another.

The casing section 808 is the one that defines the compartment 802 and holds the mechanical CVT 4. The casing section 808 connects to the engine block (not shown) of the earth working vehicle (e.g., tractor) at one end 810 and connects at the other end 812 to casing section 814 that defines the compartment 804. The end 810 of the casing section 808 has a peripheral flange 816 that connects with a mating flange (not shown) on the engine block side via bolts 818. Accordingly, both flanges meet along an imaginary plane that is perpendicular to the axis of the input shaft 3 and the output shaft 500. The end 810 of the casing section 808 has a wall (not shown) that is coplanar with the flange 816 so as to isolate the casing section 808 from the engine block. Only the shaft 3 passes through that wall and it is sealed by using an O-ring. In this fashion, the casing section 808 is sealed against any exchange of fluids from the components of the earth working vehicle (e.g., tractor) at the engine block side.

The end 812 is constructed in a similar fashion and has similar features, in particular a flange 820 that lies in a plane perpendicular to the axis of the shaft 3. The end is also closed by a wall 822 except for apertures to allow the shaft 3 and the shaft driving the differential to pass. Those apertures are sealed by using O-rings such as to prevent any fluid exchange with the casing section 814.

The casing section 808 holds the mechanical CVT 4 and any other accessories necessary for its operation. One such accessory is the lubrication system of the mechanical CVT 4. The lubrication system is designed to spray or otherwise dispense oil to the various components of the mechanical CVT 4, in particular between the races and the traction rollers (described later) to prevent slippage therebetween. The lubrication system for the mechanical CVT 4 includes a supply of oil, a lubrication circuit through which the oil is being distributed to the various components of the mechanical CVT 4 and an oil pump that pump the oil along the lubrication circuit. In the example shown in the drawings, the bottom of the casing portion 808 constitutes the oil sump where the oil resides. The oil pump draws the oil from the oil sump and distributes the oil via the lubrication circuit. The oil then drains back by gravity into the sump. The lubrication system can include a temperature sensor to measure the temperature of the oil. The temperature sensor issues a signal indicative of the oil temperature that can be used to drive an indicator on the control panel of the earth working vehicle (e.g., tractor) or trigger an alarm if the oil is outside the normal operation range. Also, the lubrication system can include an oil cooler that is designed to reduce the temperature of the oil. The oil cooler is in the form of a heat exchanger that allows heat from the oil to be transferred to another medium, such as air or liquid. To enhance the operation of the oil cooler it can be provided with a fan or any other suitable device to force an air circulation through the oil cooler and thus increase the heat transfer out of the oil. The fan can be triggered by the temperature sensor.

In a possible variant, the lubrication system is provided with a filter to remove impurities collecting in the oil. The filter is placed in any suitable location such that the oil pumped along the lubrication circuit passes through the filter. Preferably, the filter is mounted outside the casing section 808 for it to be removable and replaceable. In addition, it can also be considered to provide the lubrication system with an oil level sensor that will allow detecting a low level condition and notify the driver such to allow the mechanical CVT 4 to operate and be damaged. The oil level sensor can be of a known type and it typically would be mounted to the casing section 808 at a location where it is in contact or can read the oil collecting in the oil sump.

Because the mechanical CVT 4 is of the traction type the oil it employs is a special lubricant known as traction oil. Under low contact pressures, this lubricant behaves like normal oil but when contact pressure is sufficiently high, the oil enters an elasto-hydrodynamic phase, wherein the lubricant exhibits traction properties. In other words, instead of having a traction coefficient of around 0.03 (as for normal oil), the traction oil now has a traction coefficient of at least 0.05, preferably of at least 0.06, more preferably of at least 0.07, even more preferably of at least 0.08 and most preferably of at least 0.09. Note that for the purpose of the present specification, the traction coefficients values mentioned herein are determined at an oil temperature of 85 degrees Celsius.

The high contact pressures arise at the contact surfaces between the traction rollers and the races in the mechanical CVT 4. In use, without suitable traction oil the traction rollers may start slipping and instead of the normal rolling contact with the races, a sliding contact will arise that may very rapidly damage the surfaces of the races and render the mechanical CVT 4 unusable.

The advantage of using an oil cooler in the lubrication system is to prevent the oil from overheating but most importantly to maintain the oil at a temperature at which its traction properties are enhanced. Since the traction coefficient varies with the oil viscosity (the traction coefficient increases with viscosity) it then follows that from the perspective of enhancing traction the oil used should be as viscous as possible. On the other hand, very viscous oil is undesirable because it creates parasitic losses in the mechanical CVT 4. Accordingly, there is a temperature range of the oil where the oil is at its optimum viscosity which provides good traction while without excessive parasitic losses. Experiments have shown that this temperature range is from about 75 degrees C. to about 95 degrees C, preferably from about 80 degrees C. to about 90 degrees C. and most preferably from 80 degrees C. to about 85 degrees C.

Therefore, the oil cooler is designed such as to maintain the temperature of the traction oil in those ranges during the normal operation of the earth working vehicle (e.g., tractor). Specifically, the size of the oil cooler and its location in terms of magnitude of air flow though it, are selected such as to provide an amount of heat transfer out of the oil to keep the oil at the desired temperature. Also, if a fan is provided, the control circuitry that drives the fan and that includes the temperature sensor are designed to start and stop the fan such as to keep the temperature within the desired range.

The traction oil for the mechanical CVT 4 includes a variety of additives, including an anti-foaming additive. The traction oil may also include an anti-corrosion additive. The traction oil may further include an anti-wear additive, which has the tendency to form a coating on the operating components of the mechanical CVT 4 in the absence of rotation of the input shaft 3. Thus, for example, when the mechanical CVT 4 is not in use, the anti-wear additive protects the mechanical CVT 4. The protective coating tends to dissipate when the operating components of the mechanical CVT 4 are set in motion and the input shaft 3 begins rotating.

While not shown in the drawings, the casing section 808 is made from two or more components assembled together to form the resulting fluid-tight structure. In one possible example of implementation, the casing section 808 can be made from two halves that can meet along a plane that is parallel to shaft 3 or perpendicular to it. Obviously, many different ways exist to configure the casing section 808 such that it can be opened to allow the mechanical CVT 4 to be mounted therein at the time the drive train unit is being assembled or when a major repair needs to be performed and the entire mechanical CVT 4 needs to be removed from the casing section 808.

In instances where small repairs or adjustments need to be performed on the mechanical CVT 4, an access panel (not shown) can be provided such as to allow access to the casing section 808.

Turning now to the casing section 814, it has a peripheral flange 824 that mates with the peripheral flange 820 and it is secured thereto by bolts 826. The flanges 820 and 824 meet along a plane that is perpendicular to the axis of the shaft 3. Accordingly, the casing sections 808 and 814 can be separated from one another by removing the bolts 826. As indicated earlier the casing section 814 is provided to house the gearbox 400. It is shaped as a pan defining an internal void space where the selector boxes 118 and 140 are placed. The outer wall of the casing section has apertures to allow the shaft 3 that connects to the PTO to exist, as well as the shaft that leads to the differential and that drives the wheels. Those shafts are sealed via appropriate O-rings. Accordingly, once the casing section 814 is mounted to the casing section 808, the casing section 814 becomes fluid tight.

The components that are mounted in the casing section 814 are lubricated by oil that is different from the traction oil used to lubricate the mechanical CVT 4. The oil used in the casing section 814 can be any oil suitable to provide gear lubrication and that oil has a traction coefficient that is less than the traction coefficient of the oil. Typically, the traction coefficient of the oil used to lubricate the components in the casing section 814 is in the order of about 0.03. The lubrication system used in the casing section 814 can be designed in a similar way to the lubrication system used for the mechanical CVT 4. In particular the lubrication system includes a supply of oil, a lubrication circuit through which the oil is being distributed to the various gears and an oil pump that pump the oil along the lubrication circuit. In the example shown in the drawings the bottom of the casing portion 808 constitutes the oil sump where the oil resides. The oil pump draws the oil from the oil sump and distributes the oil via the lubrication circuit. The oil then drains back by gravity into the sump. The lubrication system can include a temperature sensor to measure the temperature of the oil. Also, the lubrication system can include an oil cooler, a filter that is removable and replaceable and a oil level sensor.

To the traction oil one may add a variety of additives, including an anti-foaming additive. The traction oil may also include an anti-corrosion additive. The traction oil may further include an anti-wear additive, which has the tendency to form a coating on the operating components of the mechanical CVT 4 in the absence of rotation of the input shaft 3. Thus, for example, when the mechanical CVT 4 is not in use, the anti-wear additive protects the mechanical CVT 4. The protective coating tends to dissipate when the operating components of the mechanical CVT are set in motion and the input shaft 3 begins rotating.

In another embodiment, it is also possible to lubricate the entire drive train (including the operating components of the mechanical CVT 4 and the gearbox 400) with the traction oil. The traction oil could therefore be drawn from a common supply. However, in this case, measures should be taken to prevent sliding surfaces (such as gear teeth and clutch plates) from being operated under contact pressures in a range that brings the oil into its elasto-hydrodynamic phase.

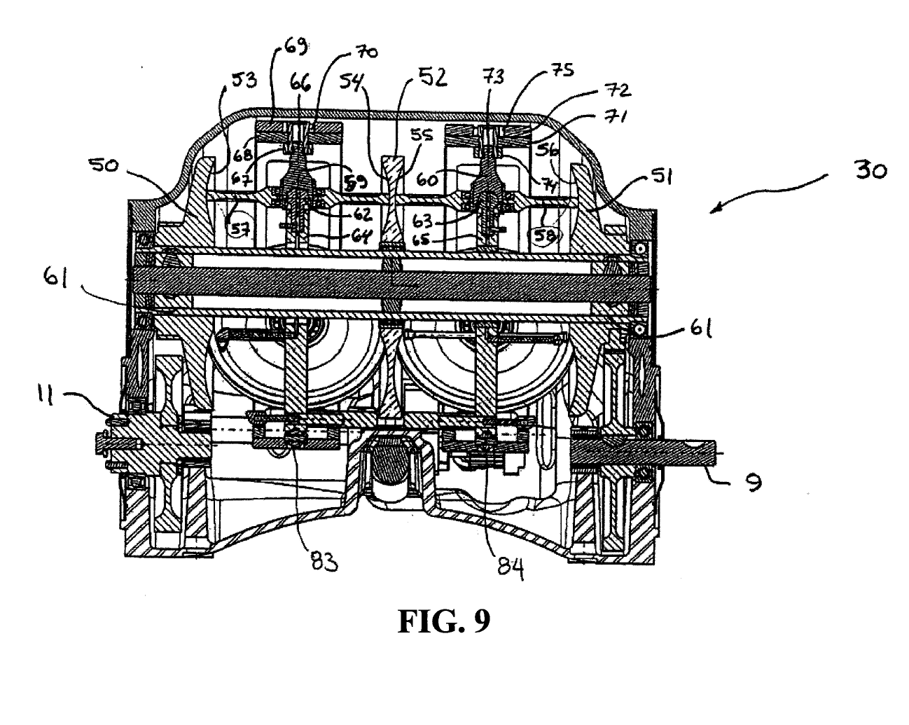

FIGS. 9 to 12 illustrate the structure of a mechanical CVT 4 that can be well suited for use in an earth working vehicle. The example shown is of mechanical CVT that has its own casing and is designed to be mated to the remaining components of the drive train unit. A somewhat different possibility is shown in FIGS. 8A through 8D and described earlier where the mechanical CVT 4 “cartridge” along with most of the other drive train unit parts, such as the gearbox 400 are mounted in a common casing that is partitioned to isolate some parts from one another.

The mechanical CVT device 30, responsible for changing the ratios as directed by the set point selection device 34 and the ratio controller 36 will now be described in more detail. The mechanical CVT device 30 is preferably a dual stage toroidal cavity roller-type continuously variable ratio transmission. In many aspects, the transmission is comparable to those of the prior art, and one may refer to U.S. Pat. No. 3,581,587 (Dickenbrock—Jun. 1, 1971—General Motors Corp.) or CA. patent application No. 2,401,474 (Careau et al.—published Mar. 5, 2004—assigned to Ecole de Technologie Superieure) for a detailed description of its basic operation.

Generally stated, the transmission comprises a pair of outer input toroidal disks 50 and 51 fixedly mounted on rotary axle 61 and driven through input shaft 50 which is driven by the internal combustion engine, and an inner double sided output toroidal disk 52 rotatably mounted about axle 61 and driving output shaft 7 through an output gear stage.

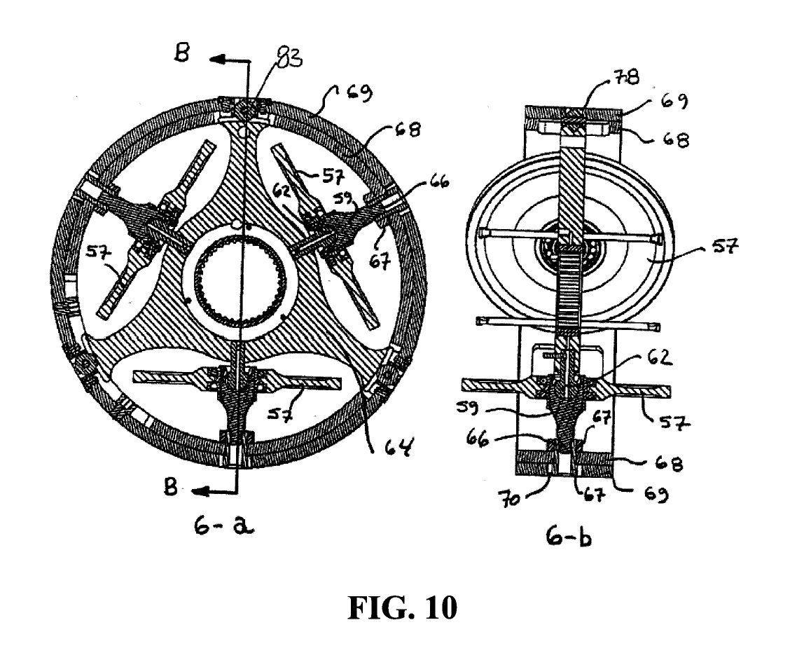

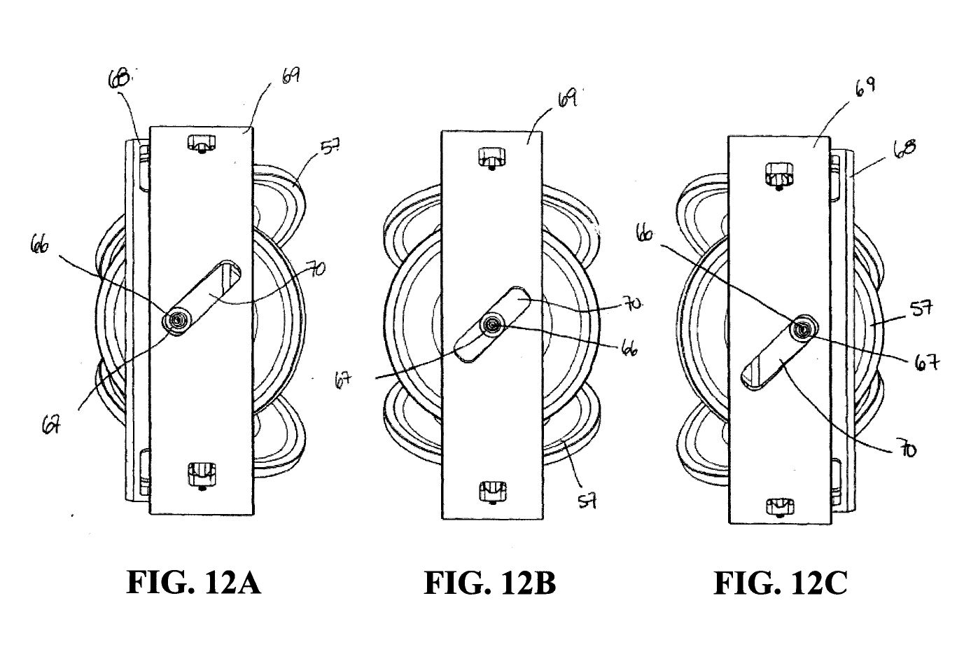

The toroidal disks 50, 51, 52 define respective toroidal races 53, 54 and 55, 56. Rotary power is symmetrically transferred from the outer input disk 50 and 51, connected through axle 61, to the inner output disk 52 through traction rollers such as 57 and 58, rotatably mounted on axially extending carriers 59,60 and running on and between two opposite races, transferring rotary power from one to the other (from outer races to inner races). A plurality of traction rollers 57,58, preferably three, are provided between each pair of races 53-54, 55-56, with their carriers 59,60 pivotally mounted on ball-shaped joints 62,63 extending from a common spider hub 64,65 rotatably mounted on axle 61 and fixedly connected to the transmission's housing. Alternatively two, four or even more rollers 57, 58 can be provided between each pair of cavities 53-54 and 55-56. The distal ends 66,73 of the carriers 59,60 of a given set of rollers 57,58 are slidably assembled to a pair of coaxial circular rings, inner ring 68,71 and outer ring 69,72, also coaxial to axle 61 and mounted at the outer perimeter of the spider hub 64,65 (see FIG. 10a). The outer ring 69, 72 is mounted on spider hub 64, 65 through a series of rollers 83, 84, one at the end of each arm of the spider hub 64, 65, which enable a limited radial movement but prevent any axial movement of the outer ring 69, 72 with respect to the fixed spider hub 64, 65. Outer ring 69, 72 is provided with three slots 70, 75 (see particularly FIGS. 12a-12c) acting as guiding sleeves or cams for guiding the displacement of distal ends 66, 73 of carriers 59,60 which are connected in three bushings 67,74 provided in the inner ring 68,71, each bushing 67,74 extending in a slot 70,75 from which a displacement force is transmitter thereto, and in turn to the distal ends 66,73. The inner ring 68, 71 is thus connected to outer ring 69, 72 and axially and radially movable with respect to said outer ring 69, 72.

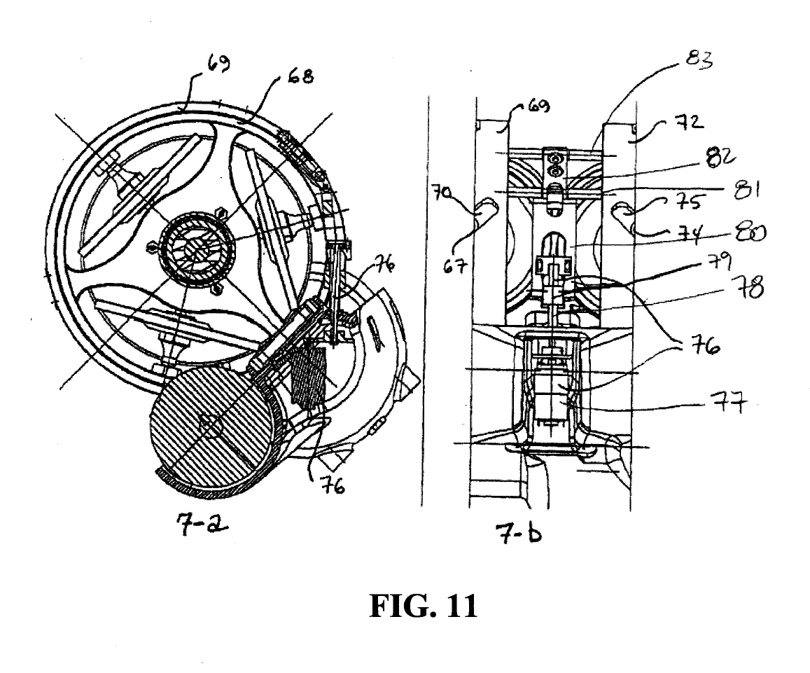

The slots 70, 75 and corresponding bushings 67,74 are provided 120 degrees apart over the circumference of the outer and inner rings 69,72; 68,71 respectively. FIGS. 10 and 11a-11b provide detailed radial cross-sectional views of the dual ring ratio control mechanism.

In operation, transmission ratio variations are carried-out by tilting the traction rollers 57,58 through displacement of the distal end 66,73 of the carriers 59,60 so that each roller 57,58 runs on a circular track of a different diameter on each opposite race 53-54 and 55-56. The ratio of the track diameters gives the transmission ratio for that given pair of disks, 50-52 and 51-52 (see FIGS. 12a-12c for different ratios). Displacement of the distal ends 66, 73 is advantageously provided through a rotation of the outer ring 69, 72 about axle 61, causing a radial force component on the inner ring 68, 71 which holds the distal end 66, 73 of the carriers 59,60. This rotation is thus causing the distal ends 66, 73 to force a tilt of the carriers 59, 60 about the ball shaped joint 62, 63. Thus the traction rollers 57,58 no longer run on a circular track but on a spiral track that, because of the opposite rotation of the pair of disks 50 (51) and 52, moves the roller's contact points up and down about the axle 61. The result of this movement of the traction rollers 57, 58 is a ratio change that forces a rotation of the carriers 59, 60 about the ball shaped joint: 62, 63.

This rotation is now in a plane perpendicular to the prior tilt plane caused by the prior rotation of the outer ring 69,72, thus this rotation of the three carriers 59,60 of the same toroidal cavity moves the distal ends 66,73 and forces an axial movement of the inner ring 68,71. However, because the inner ring 68, 71 can only move according to the three slots 70, 75, this axial movement is also transferred to a rotational movement of the inner ring 68, 71 about the axle 61 and in the opposite direction of the first outer ring 69, 72 rotation that initiated the ratio change. Once again, this rotation causes the distal ends 66, 73 to force a tilt back of the carriers 59 about the ball shaped joint 62, 63 and then the three traction rollers 57, 58 of the same toroidal cavity no longer run on a spiral track but are back on a circular track and “thus on a fixed ratio bringing the transmission back in steady state (see FIGS. 12a to 12c). The radial displacement of the outer rings 69, 72 is advantageously accomplished using a single electrically driven linear actuator 76 such as a DC motor/endless-screw tandem, a solenoid or the like. Such an electrical device 76 can be easily controlled using electrical signals.

As illustrated in FIG. 11, a single linear actuator 76 is advantageously used to simultaneously control the displacement of both outer rings 69, 72, and keep the ratio equal in both stages of the transmission 30. The actuator 76 comprises a DC geared motor 77 driving an endless screw 78 threadedly engaged in a nut 79. The nut 79 is connected to a first arm 80, which is connected through a first pin 81 to a second arm 82 at a first end thereof. The second arm 82 is connected at its second end to a second pin 83. Both the first and second pins 81, 83 interconnect the two outer rings 69, 72. thus, upon reception of a suitable command signal the motor 77 rotates the endless screw 78, which in turn translates the nut 79, which produces a translation of the first and second arms 80,82 rotating the outer rings 69,72 through the first and second pins 81,83 in a coordinated manner. The actuator 76 allows for easy and coordinated control of the ratio in both stages of the transmission 30, as opposed to traditional mechanical CVT actuators which are usually hydraulically powered and as such less energy efficient, more costly and less durable. In addition, the coordinated control of the ratio in both stages provided by the actuator 76 actuating together both outer rings 69,72, which are precisely machined and interconnected by pins 81,83, produces an improved ratio conformity between the stages which leads to an substantially high mechanical efficiency of the transmission 30.

### Electronic Controller

With reference now to FIG. 2, the earth working vehicle comprises an electronic controller 208. In one non-limiting embodiment, the electronic controller 208 is a software driven electronic device that executes programs which allow the earth working vehicle to implement various desired functions. More specifically, the electronic controller 208 has a processor that executes program code which is stored in any suitable memory device. The electronic controller 208 has a plurality of input ports that receive and process signals from various controls and sensors, as well as an operator console, and communicate the resulting data to the processor. The electronic controller 208 also has a plurality of output ports that receive control information produced by the processor and direct it to the individual components of the earth working vehicle to control them in order to accomplish the desired functions. In other embodiments, the electronic controller 208 can be implemented using hardware components that execute the processing needed to generate the desired control information that is sent to the components of the earth working vehicle.

The aforementioned operator console is equipped with a clutch pedal 202, a brake pedal 204 and an accelerator pedal 206. The accelerator pedal 206 is connected to a potentiometer (not shown) that sends a control signal 33 to an electronic controller 208. Control signal 33 conveys information about the position that the accelerator pedal 206 has acquired when operated by the driver. The clutch pedal 202 can be connected directly via a mechanical link to the main clutch 2. In such a case a switch (not shown) sends a control signal 31 that indicates to the electronic controller 208 whether the clutch pedal 202 has been actuated or not. In another possible configuration the clutch pedal 202 is connected to a potentiometer that sends control signal 31 to the electronic controller 208 proportional to the clutch position. The electronic controller 208 then uses a control signal 23 to drive an actuator on the main clutch 2 proportionally to the clutch pedal position. The brake pedal 204 is connected to a switch (not shown) that indicates to the electronic controller 208 whether the brakes are actuated or not via a control signal 32.

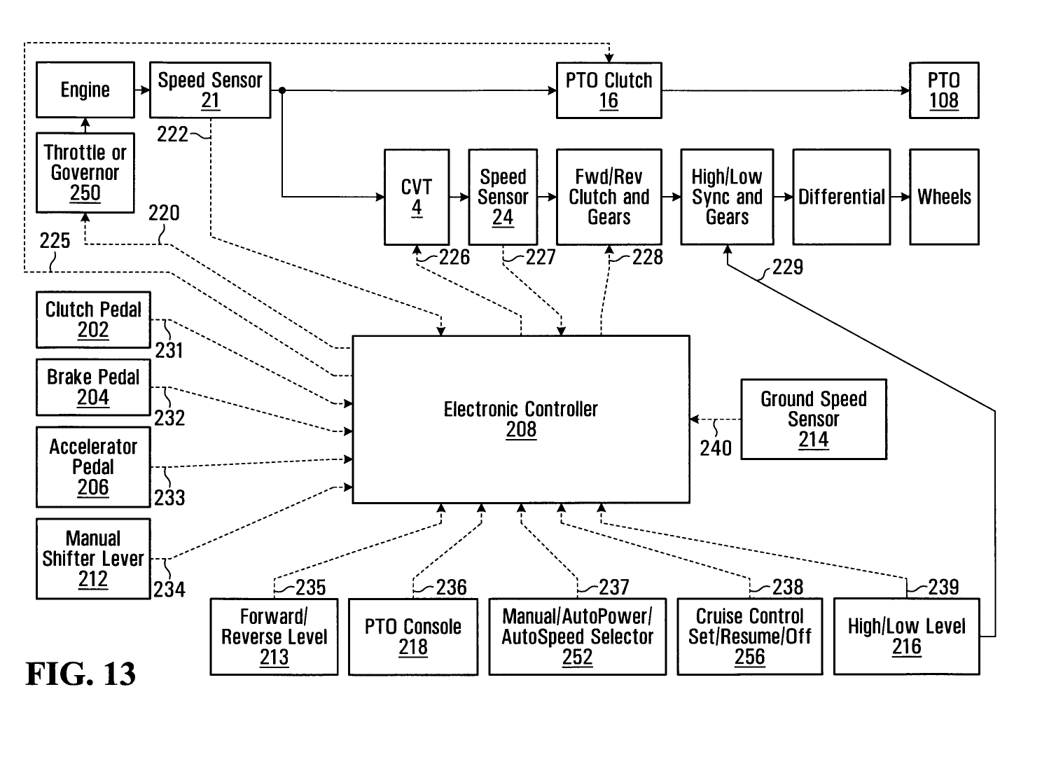

In an alternative embodiment, the main clutch 2 can be implemented as a torque converter or other coupling. In another alternate embodiment illustrated in FIG. 13, the main clutch can be placed after the mechanical CVT (rather than before) or integrated therewith.

A continuously variable control to adjust the ratio of the mechanical CVT 4 is also provided on the operator console. In a specific example of implementation this control is implemented by a manual shifter lever 212 that is connected to a potentiometer (not shown) that sends a control signal 34 proportional to the lever position. A description of how the electronic controller 208 generates a control signal 26 for control of the ratio of the mechanical CVT 4 will be provided later on.

Continuing with the description of the operator console, a high/low control 216 (e.g., a lever) is connected mechanically by a link 29 with the aforesaid synchronizer. Switches (not shown) are installed on the lever 216 and send a control signal 39 to the electronic controller 208 to indicate if the lever 216 is in low or high position. Alternatively, mechanical link 29 can be replaced by an actuator on the synchronizer driven by a control signal (not shown) from the electronic controller 208 that moves the actuator in accordance with control signal 39.

In accordance with a non-limiting embodiment, the electronic controller 208 can invoke an engine speed control loop associated with an engine speed control loop set point. Specifically, a speed sensor 21 connected to the engine detects a speed thereof, and provides the results to the electronic controller 208 in the form of a control signal 22. The engine speed control loop then acts on a fuel supply assembly (e.g., throttle/governor 220) of the engine via a control signal 20 in order the keep the engine speed in accordance with the engine speed control loop set point.

In accordance with a non-limiting embodiment, the electronic controller 208 can also invoke a mechanical CVT ratio control loop associated with a mechanical CVT ratio control loop set point, whereby an output speed sensor 24 connected to the output shaft of the mechanical CVT detects a speed of rotation thereof, and provides the results to the electronic controller 208 in the form of a control signal 27. The ratio in which the mechanical CVT 4 has been placed is a value calculated from the value of control signal 27 (from the output speed sensor 24) divided by the value of control signal 22 (from the engine speed sensor 21). The mechanical CVT ratio control loop then acts on the mechanical CVT 4 via a control signal 26 in order to keep the ratio of mechanical CVT 4 in accordance with the mechanical CVT ratio control loop set point.

The following describes how various functionality can be achieved by invoking the engine speed control loop and the mechanical CVT ratio control loop, as well as through adjustments made to the engine control loop set point and mechanical CVT ratio control loop set point, as well by control of the forward and reverse clutches and a PTO clutch 16, based on various signals received and detected by the electronic controller.

### Forward/Reverse Control

The operator console is equipped with a forward/reverse control that allows the driver to command the direction of movement of the earth working vehicle. In one embodiment, the forward/reverse control can be implemented as a manually operated forward/reverse lever 213 connected to switches (not shown) that generate a control signal 35 indicating the lever position. Control signal 35 is transmitted to the electronic controller 208. In response to control signal 35, and when other conditions are met, the electronic controller 208 generates a control signal 28 that drives the electro-hydraulically actuated powershift clutches to engage forward or reverse operation of the earth working vehicle in accordance with the driver's commands via the forward/reverse lever 213.

Depending on the earth working vehicle's driving condition, the electronic controller 208 modulates control signal 28 so as to ensure smooth and efficient shifting by the electro-hydraulically actuated powershift clutches from forward to reverse operation and vice versa. During forward/reverse shifting, normal mechanical CVT control functions are bypassed by a downshifting sequence whose rate is proportional to a vehicle ground speed signal 40, as measured by a ground speed sensor 214 (or proportional to a measured wheel speed). Once the earth working vehicle has decelerated to a predetermined ground speed, the aforesaid downshifting sequence is engaged that will completely stop the earth working vehicle and progressively accelerate it in the other direction.

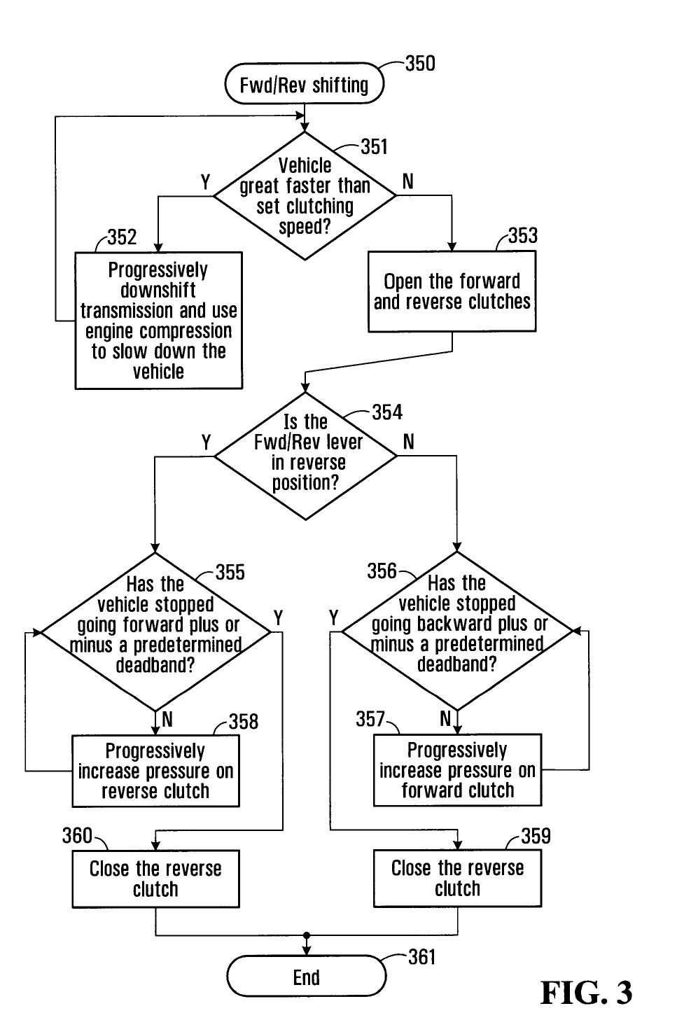

Specifically, reference is now made to FIG. 3, which is a flowchart showing example steps in the execution of a forward/reverse shifting sequence 350. This sequence can be executed by the electronic controller 208 when the driver changes the position of the forward/reverse lever 213.

Step 351: The electronic controller 208 starts by determining whether the speed of the earth working vehicle (e.g., as provided by the output speed sensor 24 via control signal 27) is above a certain clutching speed threshold which is a programmed constant in the electronic controller 208. If so, then the electronic controller 208 proceeds to step 352; otherwise, the electronic controller 208 proceeds to step 353.

Step 352: The electronic controller 208 progressively downshifts the transmission via control signal 26 and uses compression of the engine to slow down the earth working vehicle. The electronic controller 208 returns to step 351.

Step 353: At this point, the vehicle speed has reached (or was found to be no greater than) the clutching speed threshold. The electronic controller 208 opens the forward/reverse clutches via control signal 28 and proceeds to step 354.

Step 354: The electronic controller 208 determines the position of the forward/reverse lever 213. If the forward/reverse lever 213 is in forward position, the electronic controller 208 proceeds to step 355. If the forward/reverse lever 213 is in reverse position, the electronic controller 208 proceeds to step 356.

Step 356: Having determined that the forward/reverse lever 213 is in the forward position, the electronic controller 208 determines whether the earth working vehicle is still moving backwards. If so, the electronic controller 208 proceeds to step 357. If, however, the earth working vehicle has stopped moving plus or minus a deadband, then the electronic controller 208 proceeds to step 359.

Step 357: The electronic controller 208 progressively engages pressure on the forward clutch and uses engine and transmission forces to brake the earth working vehicle.

Step 359: Having determined that the earth working vehicle has stopped, the electronic controller 208 completely engages the forward clutch which, in an alternative embodiment can be implemented as a torque converter. The electronic controller 208 proceeds to step 361, which is the end of the forward/reverse shifting sequence 350.

Step 355: Having determined that the forward/reverse lever 213 is in the reverse position, the electronic controller 208 determines whether the earth working vehicle is still moving forward. If so, the electronic controller 208 proceeds to step 358. If, however, the earth working vehicle has stopped moving plus or minus a deadband, then the electronic controller 208 proceeds to step 360.

Step 358: The electronic controller 208 progressively engages pressure on the reverse clutch 8 and uses the engine and transmission forces to brake the earth working vehicle.

Step 360: Having determined that the earth working vehicle has stopped, the electronic controller 208 completely engages the reverse clutch 8 which, in an alternative embodiment can be implemented as a torque converter. The electronic controller 208 proceeds to step 361, which is the end of the forward/reverse shifting sequence 350.

Thus, movement of the earth working vehicle can be quickly and conveniently reversed. Such movement reversals are required in certain applications, such as snow removal. On traditional equipment, the driver needs to disengage the clutch and operate the brakes. The example of implementation described above is such that the driver only needs to shift the forward/reverse lever 213 and there is no need to operate the vehicle brakes nor manually operate the clutches. Moreover, the mechanical CVT can continue to turn in the same direction throughout the above operations.

### Shutdown

The operator console is also equipped with a shutdown control (not shown) that allows the driver to express an intent to shutdown the earth working vehicle and/or the engine. This intent is signaled to the electronic controller 208 in the form of a shutdown signal. In one embodiment, the shutdown signal can be issued upon detecting that a key has been removed from a key slot. Alternatively, the shutdown signal can be issued upon detecting that a designated button or knob on the operator console has been depressed. Upon receiving or detecting the shutdown signal, the electronic controller 208 progressively downshifts the transmission via control signal 26 and uses compression of the engine to slow down the earth working vehicle in the event that it is moving.

### PTO Console

A PTO console 218 is also provided. The PTO console 218 sends a control signal 36 to the electronic controller 208 to convey two elements of information. First, the desired engine speed to be maintained in order to keep the PTO speed at a driver-selected value and second, whether the PTO clutch 16 should be engaged or disengaged. The electronic controller 208 uses a control signal 25 to engage/disengage the PTO clutch 16. To keep the engine speed constant, the electronic controller 208 sets the engine speed control loop set point (used by the aforementioned engine speed control loop) to the desired engine speed, which will result in the PTO speed being kept at a driver-selected value. In an embodiment, the engine speed control loop set point received from the PTO console 218 via control signal 36 has priority over other engine speed set points that may be considered by the engine speed control loop.

### Manual/Automatic Modes of Operation

A manual/automatic power/automatic speed selector 222 is also provided. The manual/automatic power/automatic speed selector 222 sends a control signal 37 to the electronic controller 208 to indicate in which speed mode (i.e., “manual”, “automatic power” or “automatic speed”) the driver wishes to drive the earth working vehicle.

### Manual Mode

In “manual” mode, control signal 33 (i.e., from the accelerator pedal 206) directly controls a fuel supply assembly (not shown) of the engine, which in a non-limiting embodiment may be a diesel internal combustion engine, to regulate the engine speed. Specifically, control signal 33 indicates the position of the accelerator pedal 206, which determines in proportional fashion the amount of fuel the engine will receive; in an alternative embodiment, the accelerator pedal 206 could be connected directly to the throttle/governor 220 via mechanical linkages). Another possible approach is to invoke a closed loop function such that the position of the accelerator pedal 206 determines the engine RPM. The driver of the earth working vehicle can then use the manual shifter lever 212 (which outputs control signal 34) to directly set the ratio of the mechanical CVT 4 in order to obtain the desired vehicle speed. As indicated earlier, the manual shifter lever 212 is continuously variable and provides a virtually infinite number of ratios within a given range, in contrast to more traditional transmissions that only allow a limited set or ratios. Control signal 34 that is output by the manual shifter lever 212 conveys the position of the shifter lever 212 and it is used by the electronic controller 208 as the mechanical CVT ratio control loop set point, as used in the aforementioned mechanical CVT control loop threshold to control the ratio of the mechanical CVT 4.

### Automatic Power Mode

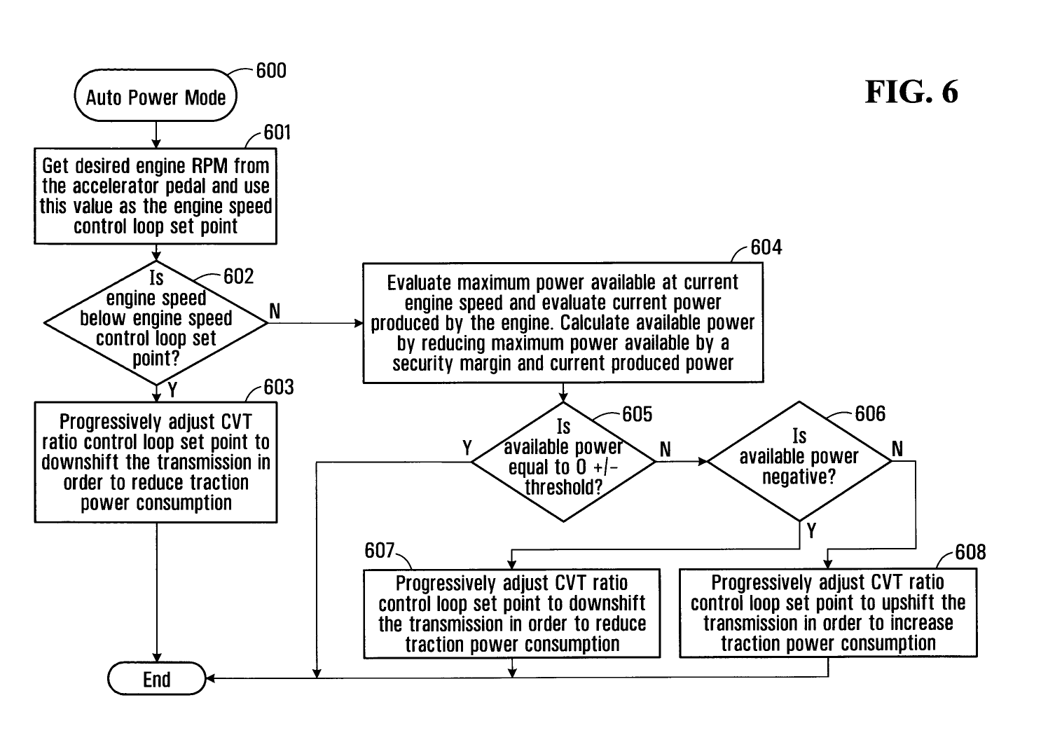

In “automatic power” mode, also referred to as “productivity” mode, and which is detailed in the flowchart on FIG. 6, the driver sets the desired working engine speed by pressing the accelerator pedal 206. Therefore, control signal 33 that is produced by the accelerator pedal 206 determines the desired engine RPM. It is known that engine speed is proportional to the power that the engine can produce thus the driver has also implicitly set the maximum engine working power through the accelerator pedal 206.

The engine speed control loop is then invoked, and the engine speed control loop set point is set to the desired engine RPM mentioned above. Also, the electronic controller 208 calculates the mechanical CVT ratio control loop set point in order to get maximum traction speed from the selected engine power. In particular, the electronic controller 208 evaluates in real time the produced engine power. This can be achieved in many ways. For example, the electronic controller 208 can monitor control signal 20 (to the throttle/governor 220), which is proportional to the injected fuel rate, which is itself proportional to the engine power. One other way would be to use a torque sensor (not shown) placed on the engine output shaft and the electronic controller 208 can calculate the engine power by multiplying the output signal of the torque sensor by the engine speed signal. The electronic controller 208 also has knowledge of the maximum engine power available at the selected engine speed. This information can be found in a memory map residing in the electronic controller 208 providing the maximum engine torque for the complete range of RPM values the engine will experience. The torque produced by the engine can also be implicitly determined under certain instances, for example in the case where the electronic controller 208 relies on control signal 20, where the maximum engine power is reached when the pulse width modulation (PWM) duty cycle for that control signal is at 100%.

Independently of the method that is being used to measure real time engine power and maximum available engine power, the electronic controller 208 will adjust the mechanical CVT ratio control loop set point in order the keep the engine in a predetermined power band (e.g., example 90-95%), and thus obtain the maximum wheel speed from the selected power. To avoid engine overheating and to keep a certain margin so that the engine speed control loop can adjust engine speed, the electronic controller 208 can reserve a predetermined power security margin (e.g., 5% in this case). The electronic controller 208 can adjust the mechanical CVT ratio control loop set point many times per second to follow changing driving conditions.

This method of operation is useful in instances where the RPM of the engine has to be kept stable and it is desired to provide the wheels with at least a certain percentage of the available power. The electronic controller 208 regulates the amount of fuel injected into the engine and at the same time it varies the ratio of the mechanical CVT 4 such as to control the amount of power to the wheels while keeping the RPM at the set value. Consider for example the case where the earth working vehicle, which can be a tractor, is descending a slope. Since the load on the engine is decreasing (gravity pulls the tractor forward), the electronic controller will upshift the mechanical CVT to increase the speed of the earth working vehicle (e.g., tractor) and thus maintain the load on the engine. Depending on the particular control strategy selected it may be necessary to also reduce the fuel injected into the engine. In a different example, consider now that the earth working vehicle (e.g., tractor) is climbing a hill. Here the load on the engine increases and the electronic controller will downshift the mechanical CVT and possibly at the same time increase the amount of fuel injected into the engine.

The aforesaid control strategy allows the power produced by the engine to be maintained above a certain threshold (e.g., 80% of the total available engine power, 85%, 90% or 95%, in various non-limiting embodiments) while keeping the RPM stable. A stable RPM may be required in cases where the PTO drives equipment that has to operate a set rotational speed.

Reference is now made to FIG. 6, which is a flowchart showing example steps in the execution of an Automatic Power Mode function 600. This function can be executed by the electronic controller 208 several times per second to adjust the engine speed control loop set point and the mechanical CVT ratio control loop set point, and is applicable to the scenario where the driver engages the automatic power mode.

Step 601: the electronic controller 208 determines the desired engine speed given by the position of the accelerator pedal 206 and consequently adjusts the engine speed control loop set point. The electronic controller proceeds to step 602.

Step 602: The electronic controller 208 determines whether the speed of the earth working vehicle (e.g., as provided by the output speed sensor 24 via control signal 27) is below the engine speed control loop set point as determined at step 601. If so, then the electronic controller 208 proceeds to step 603; otherwise, the electronic controller 208 proceeds to step 604.

Step 603: This means that the engine needs help from the mechanical CVT 4 to increase its speed. The electronic controller 208 then progressively changes the mechanical CVT ratio control loop set point to downshift the transmission and thus reduce traction power consumption, which also helps engine acceleration.

Step 604: Having determined that the engine speed control loop set point has been met, the electronic controller 208 determines the maximum available engine power at the given engine speed. The electronic controller also evaluates the power currently being produced by the engine. By subtracting the power currently being produced by the engine and a security margin from the maximum available power at the given speed, one obtains the available power at the engine. There are many ways to evaluate these parameters such as using a memorized map that tells the maximum engine power or torque at every operating speed and indexing this table with detected speed gives the maximum power available. The current engine-produced power can be calculated by multiplying the value from a torque sensing device connected at the engine's output by the speed of the engine. One other simpler way to evaluate available power is to measure the position of the throttle/governor 220 (or PWM duty cycle) knowing that the maximum position (or 100% PWM duty cycle) means that the engine is at maximum power/torque for the given RPM thus subtracting from the maximum lever position value (or 100% PMW value) the current lever position plus a security margin gives a value proportional to the available engine power. The electronic controller 208 then proceeds to step 605.

Step 605: Knowing the available power at the engine, the electronic controller 208 determines whether this value is equal to zero (plus or minus a pre-programmed threshold). If so the engine power output is maximized and there is no need for further adjustments. Otherwise, the electronic controller 208 proceeds to step 606.

Step 606: The electronic controller 208 evaluates if available power is negative. If so, the electronic controller 208 proceeds to step 607; otherwise, the electronic controller 208 proceeds to step 608.

Step 607: The electronic controller 208 progressively changes the mechanical CVT ratio control loop set point to downshift the transmission and thus reduce traction power consumption.

Step 608: This means that power can be retrieved from the engine and the electronic controller 208 will act on the mechanical CVT ratio control loop set point in order to progressively upshift the transmission, thus increasing the traction power consumption.

### Automatic Speed Mode

In “automatic speed” mode, the accelerator pedal 206 controls the vehicle speed. The electronic controller 208 receives control signal 33 from the accelerator pedal 206, which establishes a driver-selected “vehicle speed set point”. The electronic controller 208 compares this signal to control signal 40 from the ground speed sensor 214. If the vehicle speed set point is equal to the detected ground speed (plus or minus a predetermined dead band, which is a null zone within which no correction is attempted), current operating conditions are considered to be in a steady state. If, however, the detected ground speed is not within the dead band then current operating conditions are considered to be in a transient state. When a transient state of operation is reached, and in an embodiment of the present invention, the electronic controller 208 will increase/decrease the engine speed as a function of (e.g., proportionally to) the difference between the vehicle speed set point and the detected ground speed. This can be achieved by increasing/decreasing the engine speed control loop set point used by the engine speed control loop. The ratio of the mechanical CVT 4 is also adjusted via control signal 26.

If acceleration is required, the electronic controller 208 implements a first downshifting ramp until the engine speed control loop set point is reached and a second upshifting ramp until the earth working vehicle reaches the vehicle speed set point (while maintaining the RPM at the engine speed control loop set point). On the other hand, if deceleration is required, the electronic controller 208 implements a downshifting ramp, as a function of (e.g., proportional to) the difference between the vehicle speed set point and the detected ground speed, and will use compression of the engine to slow down the earth working vehicle.

Once operating conditions return to the steady state, the electronic controller 208 will determine the power currently produced by the engine by the same means as discussed earlier. Knowing the currently produced power, the electronic controller 208 can search an efficiency memory map stored in the electronic controller 208 that maps the speed at which the engine should be operated to generate the power that is being currently produced with optimal fuel efficiency. The electronic controller 208 will then change the engine speed control loop set point of the engine speed control loop to equal the value from the efficiency map and also calculate a new mechanical CVT ratio control loop set point so that the earth working vehicle keeps the same speed.

It is known that slippage can occur between the vehicle wheels and the ground thus the required vehicle wheel speed calculation to keep the proper ground speed should take into account the percentage of wheel slippage which can be calculated by, e.g., a ratio of the value of control signal 27 (from the output speed sensor 24 at the output of the mechanical CVT 4) and the value of control signal 40 (from the ground speed sensor 214).

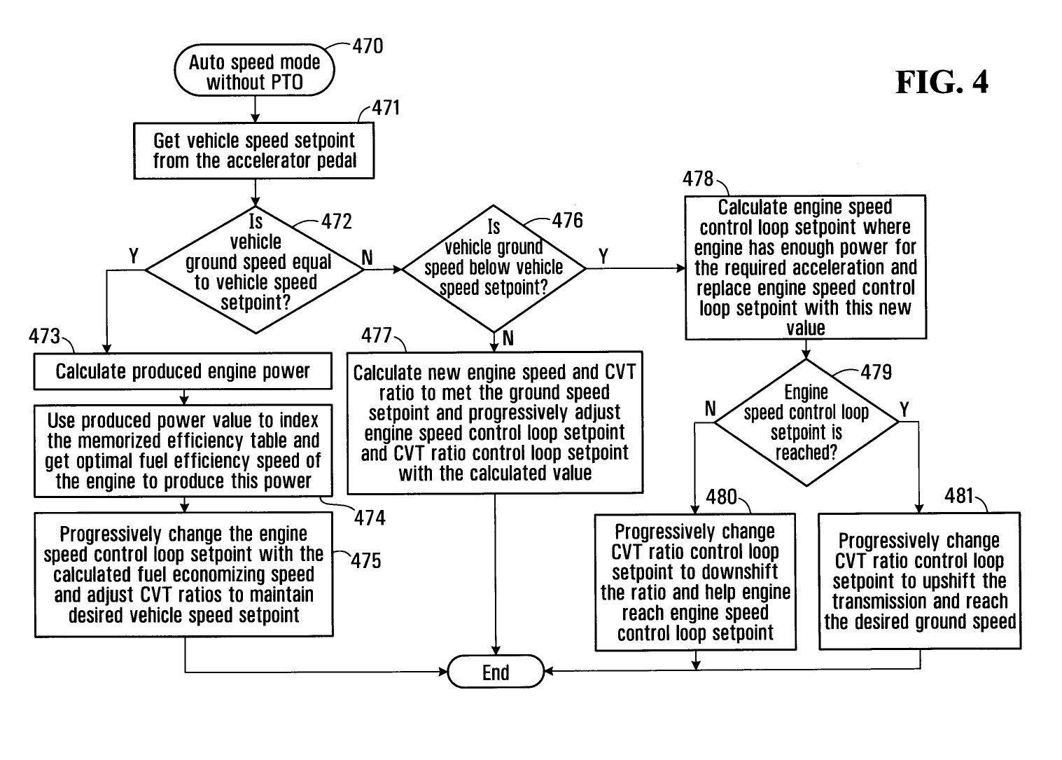

Reference is now made to FIG. 4, which is a flowchart showing example steps in the execution of an “Automatic Speed Mode without PTO” function 470. This function can be executed by the electronic controller 208 several times per second, and is applicable to the scenario where the driver engages the automatic speed mode and the earth working vehicle is not using the PTO.

Step 471: the electronic controller 208 determines the driver-selected “ground speed set point” given by the position of the accelerator pedal 206. The electronic controller 208 proceeds to step 472.

Step 472: The electronic controller 208 determines whether the speed of the earth working vehicle (e.g., as provided by the speed sensor 24 via control signal 27) is equal to the ground speed set point determined at step 471. If so, then the electronic controller 208 proceeds to step 473; otherwise, the electronic controller 208 proceeds to step 476.

Step 473: The vehicle speed is recognized to be in steady state and the electronic controller 208 enters a fuel economy mode. To this end, the power currently produced by the engine is calculated. The electronic controller 208 then proceeds to step 474.

Step 474: The electronic controller 208 uses the current power computed at step 473 to index an efficiency table pre programmed in a memory, which associates each power with a preferred engine speed where a maximum fuel economy is reached. The electronic controller 208 then proceeds to step 475.

Step 475: The engine speed control loop set point is then progressively adjusted to meet the fuel economizing speed and the mechanical CVT ratio control loop set point is adjusted so as to keep the vehicle ground speed constant.

Step 476: The vehicle ground speed is recognized to be in a transient state and the electronic controller 208 verifies whether the earth working vehicle is going faster or slower than the ground speed set point. If the earth working vehicle is going too fast, the electronic controller 208 proceeds to step 477; if the earth working vehicle is going too slow, the electronic controller 208 proceeds to step 478.

Step 477: The electronic controller 208 calculates the new engine speed and mechanical CVT ratio to meet the required ground speed, and their respective control loop set points are progressively changed so as to slow down the earth working vehicle.

Step 478: The electronic controller 208 determines a proper engine speed in order to give the earth working vehicle enough power for the required acceleration, and changes the engine speed control loop set point to this new value. The electronic controller 208 proceeds to step 479.

Step 479: The electronic controller 208 determines whether the engine speed has reached the ground speed set point to within a preprogrammed dead band. If not, the electronic controller 208 proceeds to step 480; otherwise, the electronic controller 208 proceeds to step 481.

Step 480: This means that the engine needs help from the transmission to accelerate. To this end, the electronic controller 208 adjusts the mechanical CVT ratio control loop set point to downshift the transmission.

Step 481: Since the engine speed has been found to be in the dead band, the electronic controller 208 adjusts the mechanical CVT ratio control loop set point so as to progressively upshift the mechanical CVT to reach the desired ground speed.

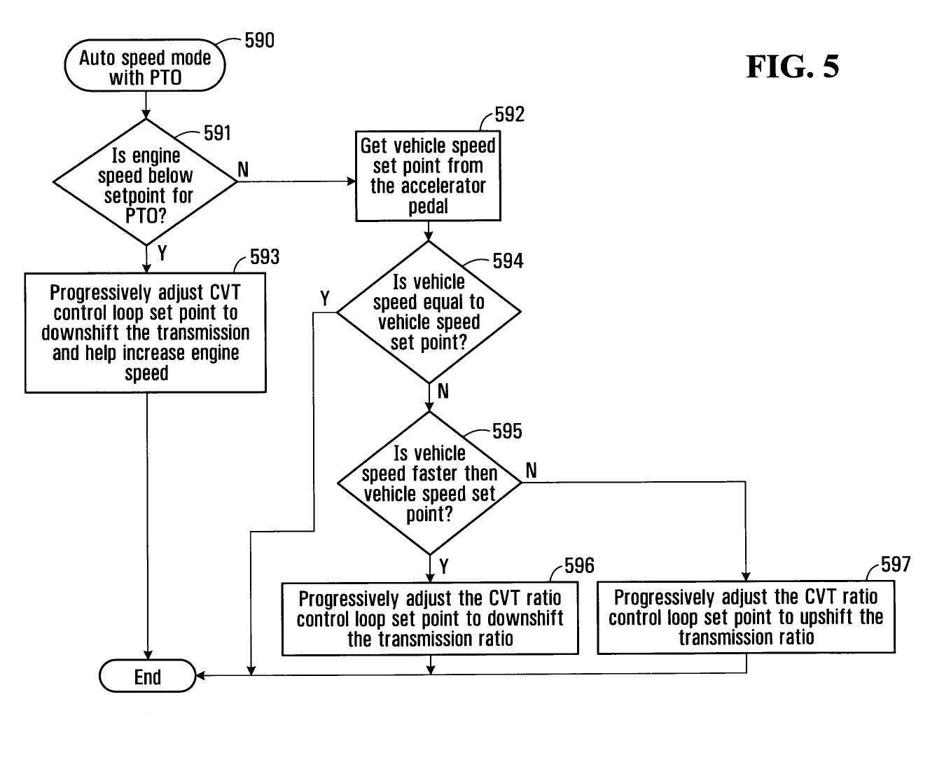

Reference is now made to FIG. 5, which is a flowchart showing example steps in the execution of an Automatic Speed Mode with PTO function 590. This function can be executed by the electronic controller 208 several times per second to adjust the engine speed control loop set point and the mechanical CVT ratio control loop set point, and is applicable to the scenario where the driver engages the automatic speed mode and the earth working vehicle is using the PTO.

Step 591: When the PTO is engaged, the electronic controller 208 places a priority on keeping the engine speed constant to have a stable PTO output. Accordingly, the electronic controller 208 determines whether the engine speed respects the engine speed control loop set point. If not, the electronic controller 208 proceeds to step 592; otherwise, the electronic controller 208 proceeds to step 593.

Step 593: The electronic controller 208 progressively downshift the mechanical CVT to help the engine accelerate to its proper speed.

Step 592: The electronic controller 208 reads the ground speed as well as the aforementioned ground speed set point. The electronic controller 208 proceeds to step 594.

Step 594: The electronic controller 208 determines whether the vehicle ground speed matches the ground speed set point. If so, the controller keeps the mechanical CVT ratio control loop set point unchanged, but if the ground speed does not match the ground speed set point, the electronic controller 208 proceeds to step 595.

Step 595: Since it does not match, the electronic controller 208 determines whether the ground speed is above or below the ground speed set point. If it is above, then the electronic controller proceeds to step 596; otherwise, the electronic controller proceeds to step 597.

Step 596: The electronic controller 208 progressively changes the mechanical CVT ratio control loop set point to downshift the transmission.

Step 597: The electronic controller 208 will change the mechanical CVT ratio control loop set point in order to progressively upshift the transmission, thus increasing the vehicle speed.

### Cruise Control

In a possible variant, the earth working vehicle is provided with a cruise control function. As in the case with the functions discussed earlier, the cruise control function can be implemented by executing software in the electronic controller 208.

The driver is provided with a cruise control selector 226 in the cabin that allows activation of the cruise control function. In a non-limiting embodiment, the cruise control selector 226 may include a set of single-function buttons such “set” button, a “resume” button, an “accel/decel” button, an “off” button or one or more multi-function buttons. The output of the cruise control selector 226 is a control signal 38 provided to the electronic controller 208. To activate the cruise control function, the driver simply has to push the “set” button or its equivalent. In manual mode (i.e., if the manual/automatic power/automatic speed selector 222 is in “manual” mode), pressing the “set” button or its equivalent will result in the electronic controller 208 recording the current vehicle ground speed and adjusting the engine speed control loop set point to keep the vehicle ground speed constant without acting on the mechanical CVT. In automatic power and speed modes, pressing the cruise control “set” button or its equivalent will result in the electronic controller 208 memorizing the desired engine RPM or vehicle speed set point given by the accelerator pedal 206 thus allowing the driver to remove his/her foot from the pedal. Using the “accel/decel” button or its equivalent, the driver can increase/decrease the desired engine RPM or vehicle speed set point of the chosen mode. At any moment, pressing the brake pedal 204 or the cruise control “off” button or its equivalent will shut down the cruise control function, giving control back to the driver via the accelerator pedal 206.

In a possible variant, the earth working vehicle is provided with a cruise control function that uses the true ground speed of the earth working vehicle for a more precise operation. The ground speed sensor 214 is connected to the wheels of the earth working vehicle and provides accurate vehicle speed information via control signal 40 as long as there is no slippage. In the event of slippage, the speed information relayed to the electronic controller 208 is inaccurate and the true vehicle speed drifts from the desired value. A possible improvement is to use instead of a ground speed sensor 214 that is connected to the wheels a true ground speed sensor that accurately reports the ground speed of the earth working vehicle irrespective of slippage at the wheels. An example of a true ground speed sensor is the non-contact sensor that is mounted on the earth working vehicle pointed to the ground and measures the speed of the earth working vehicle relative to the ground. The sensor has a radar antenna that issues a radar beam toward the ground which is reflected back toward the sensor. By processing the reflection, an accurate measurement of the ground speed can be obtained.

### Headland Turn Sequence

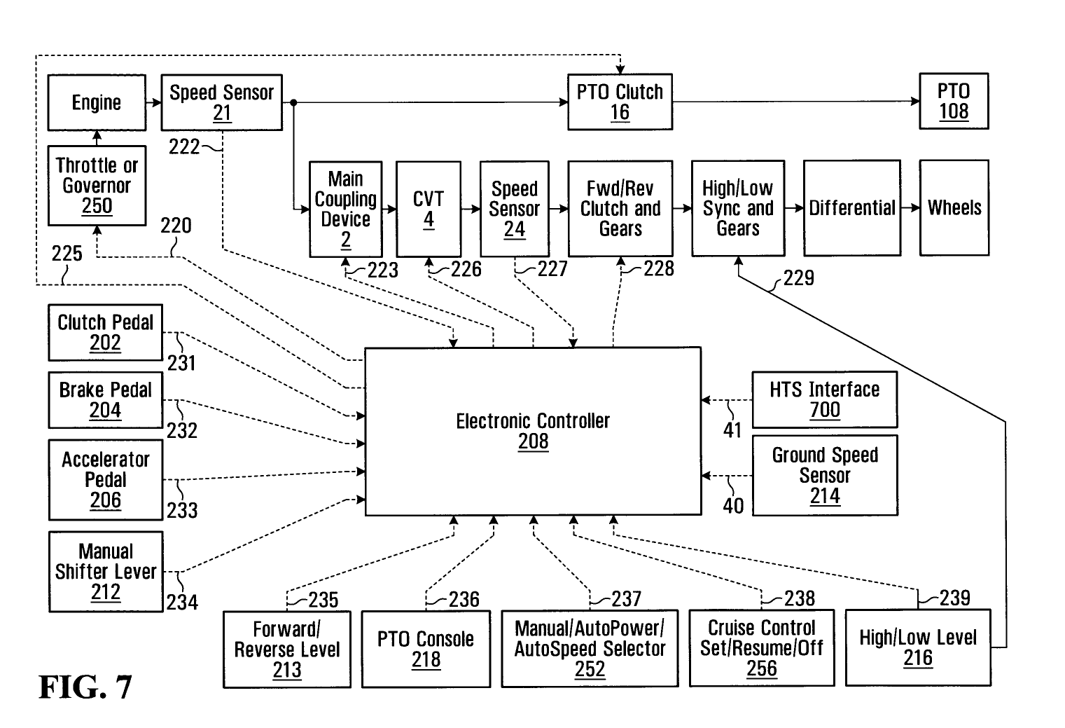

In accordance with a non-limiting embodiment, the earth working vehicle also provides a HTS (Headland turn sequence) function, which can be implemented by the electronic controller 208 (e.g., in FIG. 2). Alternatively, the HTS function can be implemented by a separate HTS controller (not shown) connected to the electronic controller 208 by a network connection (not shown). With reference to FIG. 7, an HTS interface 700 is provided, which issues a control signal 41 to the electronic controller 208 indicative of a selected HTS operation (e.g., lift action, PTO action). Control signal 41 also conveys whether the operator has engaged or disengaged the HTS mode of operation, e.g., by pressing an HTS begin/end button or other actuator.

The HTS function implemented by the electronic controller 208 allows enhanced HTS functionality, which goes beyond simply engaging/disengaging the PTO clutch 16 and putting a rear tractor lift up or down. Rather, the electronic controller 208 allows the driver to mix the cruise control function with the aforesaid HTS function. Specifically, the driver first sets the required HTS operation (lift action, PTO action) via the HTS interface 700, sets the required driving mode (manual, automatic power, automatic speed) via the manual/automatic power/automatic speed selector 222, sets the cruise control function via the cruise control selector 226 and then pushes the HTS begin/end button to start an HTS sequence. This is done once for the first row. Then, when the earth working vehicle is near the headland, pressing the HTS begin/end button will automatically disengage the cruise control function, bring the tractor lift up and disengage the PTO clutch 16. The driver can then turn and align the tractor in the next row and then, by a simple touch of the HTS begin/end button bring the tractor lift down, engage the PTO clutch 16 and resume the cruise control function, thus bringing the earth working vehicle into the exact same conditions (engine, traction and PTO speeds) as were prevalent when the HTS begin/end button was first pressed.

In a specific example, consider the case where the earth working vehicle powers an earth working implement, such as via the PTO or pulling it. In the case of an earth working implement attached via the PTO, the driver is assumed to have selected via the PTO console 218 a desired engine speed and to engage the PTO clutch 16. This selection is conveyed to the electronic controller 208 by control signal 36, in response to which the electronic controller 208 issues a control signal to the earth working implement and/or control signal 25 to the PTO clutch 16. The driver of the earth working vehicle is also assumed to have selected the “set” button via the cruise control selector 226. This selection is conveyed to the electronic controller 208 by control signal 38, in response to which the electronic controller 208 determines a preset value for the speed of the earth working vehicle and issues control signals (e.g., control signals 20 and 26) to the mechanical CVT 4 and to the fuel supply assembly of the engine to vary the ratio of the mechanical CVT 4 and the amount of power produced by the engine to maintain a speed of the earth working vehicle at the preset value. The driver is also assumed to have selected a mode of operation via the manual/automatic power/automatic speed selector 222.

The driver then pushes the HTS begin/end button and operates the earth working vehicle. While the earth working vehicle travels at the set speed, the PTO clutch 16 establishes a power flow from the earth working vehicle to the working implement. Moreover, in the case where the earth working implement is attached via the PTO, the PTO operates at a speed proportional to the desired engine speed.

Now, the driver can push the HTS begin/end button via the HTS interface 700, thus resulting in a temporary termination of the power flow from the earth working vehicle to the earth working implement. This can be done, for example when the earth working vehicle is near the headland and needs to initiate a turn. When this mode of operation is selected (e.g., by pushing the HTS begin/end button), the PTO clutch 16 can be opened or in the case of a load that is being pulled, the load can be lifted off the ground. This is effected by the electronic controller 208 by issuing the necessary control signals to the earth working implement.

Assuming the headland turn is completed, the driver can push the HTS begin/end button a second time, which causes the electronic controller 208 to issue a further control signal to the earth working implement to re-establish a power flow from the earth working vehicle to the earth working implement and continue issuing control signals to the mechanical CVT 4 and to the fuel supply assembly of the engine to vary a ratio of the mechanical CVT 4 and an amount of power produced by the engine to maintain a speed of the earth working vehicle at the preset value.

Thus, one will appreciate that embodiments of the present invention include a user friendly control for an earth working vehicle, in which a driver can access traditional accelerator, brake and clutch pedals, as well as a forward/reverse lever, a manual shifter lever, a high/low lever, a PTO console, a cruise control selector and a manual/automatic power/automatic speed selector.

In manual mode, the earth working vehicle is operated as usual with the accelerator pedal controlling the engine speed and the manual shifter lever controlling the current ratio of the transmission. The main difference is that instead of having to clutch in order to change one ratio to another, the driver simply changes the manual shifter lever position to access any speed in the virtually infinite ratio range between the minimum and maximum ratio that correspond to the minimum and maximum positions of the lever. While shifting, the engine is maintained in engagement from traction.

In automatic power (productivity) mode, the driver sets the desired maximum power to be produced by the engine by actuating the accelerator pedal. This pedal selects engine speed which is proportional to the power that the engine can produce. Thus from this selected power the electronic controller will automatically change the transmission ratio to get the maximum traction speed. This mode can advantageously be used in PTO applications where the engine speed is proportional the PTO speed that must remain near constant. Using this mode, the electronic controller will bring the earth working vehicle to its maximum speed available after the subtraction of the PTO power from the selected operation engine power. This speed will automatically adjust to consume all the selected engine power but to keep the engine speed/power constant thus keeping the PTO speed constant.

In automatic speed mode, the amount by which the accelerator pedal is actuated is now proportional to the vehicle ground speed. The electronic controller will then adjust automatically the engine speed and the transmission ratio to reach the vehicle speed set point. In a transient state, when the driver changes the desired vehicle speed, the electronic controller will react proportionally to the required variation. Wider variations will lead to higher engine power/compression sought by the electronic controller for that variation, and higher ratio upshifting/downshifting rates will be applied. In a steady state, where the vehicle speed set point is reached, the electronic controller will overdrive the transmission to reduce the engine speed to the proper fuel economizing speed thus producing an energy efficient way of operating the earth working vehicle and maintaining the speed of the earth working vehicle at the vehicle speed set point. If the PTO mode is activated, this feature is bypassed and the engine speed remains at the selected level required to maintain the proper PTO speed. The electronic controller can then only act on the transmission ratio to maintain the desired vehicle speed.

In all modes, the driver can use a cruise control function. In manual mode, the driver can activate the cruise control function by selecting a desired ground speed that is to be maintained by the electronic controller using the engine throttle/governor. In automatic power (productivity) mode, activating the cruise control function will set the engine speed control loop set point to the current conditions under which the earth working vehicle is being operated, thus allowing the driver the remove his/her foot from the accelerator pedal. In automatic speed mode, activating the cruise control function will memorize the ground speed set point, thus allowing once again the driver to remove his/her foot from the accelerator pedal.

The cruise control function can be activated/deactivated by on/off buttons, for example. A set button is used to set the appropriate engine speed control loop set point or vehicle speed set point. A resume button is used after the cruise control was turned off generally by applying brakes. The resume function ramp the appropriate set point from its current position to the position it was before the cruise control function was turned off. Thus, the earth working vehicle will accelerate/decelerate back to its previous set point. To ease operation, the off/resume function of the cruise control function can be properly interlocked with a HTS (headland turn sequence) function. Using this feature, the driver can activate the automatic HTS function, which could disengage the cruise control function before execution of the HTS and execute the resume function of the cruise control function to ramp the earth working vehicle back to its work speed once the HTS is completed.

Those skilled in the art will appreciate that it is possible to devise further variants and modifications without departing from the scope of the invention, which is defined by the appended claims.

1.-35. (canceled)

36. An earth working vehicle, comprising:
a. an internal combustion engine;
b. a driveline for establishing a driving relationship between said internal combustion engine and wheels of said earth working vehicle;
c. said driveline including a mechanical CVT;
d. a continuously variable control for manual operation by a driver of said earth working vehicle to adjust a ratio of said mechanical CVT;
e. an electronic controller responsive to a signal produced by said control and indicative of a position imparted by the driver to said control to generate a control signal to said mechanical CVT to cause said mechanical CVT to acquire a ratio corresponding to the position of said control.

37. An earth working vehicle as defined in claim 36, wherein said driveline includes a coupling selected from the group consisting of clutch and torque converter in a power flow path from said internal combustion engine and wheels of said vehicle, wherein said power flow path includes said mechanical CVT.

38. An earth working vehicle as defined in claim 37, including a control operable by the driver to disengage said coupling

39. An earth working vehicle as defined in claim 37, wherein said vehicle has a PTO in driven relationship with said internal combustion engine.

40.-44. (canceled)

45. An earth working vehicle, comprising:
a. an internal combustion engine;
b. a driveline for establishing a driving relationship between said internal combustion engine and wheels of said earth working vehicle;
c. said driveline including a mechanical CVT;
d. said driveline including a gearbox downstream said mechanical CVT in a direction of power flow through said driveline from said internal combustion engine to the wheels of the vehicle, said gearbox being shiftable from a first ratio to a second ratio to provide downstream of said gearbox two output torque ranges associated with said first and second ratios, respectively.

46. An earth working vehicle as defined in claim 45, wherein in each output torque range torque is continuously variable by varying a ratio of said mechanical CVT.

47. An earth working vehicle as defined in claim 45, wherein said vehicle includes a PTO in driven engagement with said internal combustion engine.

48.-113. (canceled)

114. An earth working vehicle as defined in claim 36, further comprising a control operable by the driver to select among at least two modes of operation, namely a first mode of operation and a second mode of operation, said first mode of operation corresponding to a command to cause said vehicle to move forward, said second mode of operation corresponding to a command to cause said vehicle to move backwards; wherein said electronic controller, while said vehicle is in motion, being responsive to a change of a mode of operation via said control indicating a command to reverse a direction of travel of said vehicle, to issue a control signal to said mechanical CVT to cause said mechanical CVT to downshift.

115. An earth working vehicle as defined in claim 114, wherein said driveline includes a movement reversal assembly operable in response to a control signal issued by said electronic controller to reverse a direction of travel of said vehicle, said electronic controller issuing the control signal to said movement reversal assembly to cause the direction of travel reverse subsequent issuance of said control signal to said mechanical CVT to downshift.

116. An earth working vehicle as defined in claim 115, wherein said movement reversal assembly includes a drum pack.

117. An earth working vehicle as defined in claim 116, wherein said drum pack is hydraulically operated.

118. An earth working vehicle as defined in claim 114, wherein said vehicle includes:
a. a coupling selected from the group consisting of clutch and torque converter;
b. subsequent said change of mode of operation, said electronic controller issues a control signal to said coupling to disengage said coupling and discontinue a driving engagement between said internal combustion engine and the wheels of said vehicle via said driveline.

119. An earth working vehicle as defined in claim 118, wherein said vehicle includes:
a. a sensor that generates a speed signal indicative of a speed at which said vehicle travels;
b. said electronic controller comparing the speed of said vehicle conveyed in the speed signal with a set speed value and issuing said control signal to disengage said coupling when the speed of said vehicle is less than said set speed value.

120. An earth working vehicle as defined in claim 114, wherein said vehicle has a PTO in driving relationship with said internal combustion engine.

121. A method for controlling a CVT in an earth working vehicle, the earth working vehicle comprising an internal combustion engine and a driveline including the mechanical CVT for establishing a driving relationship between the internal combustion engine and wheels of the earth working vehicle, said method comprising:
a. enabling a driver of the earth working vehicle to adjust a ratio of the mechanical CVT using a continuously variable control for manual operation;
b. receiving at an electronic controller a signal produced by the continuously variable control indicative of a position imparted by the driver to the control;
c. generating at the electronic controller a control signal for causing the mechanical CVT to acquire a ratio corresponding to the position of the continuously variable control.

122. A method as defined in claim 121, wherein the driveline includes a coupling selected from the group consisting of clutch and torque converter in a power flow path from the internal combustion engine and wheels of the earth working vehicle, wherein the power flow path includes the mechanical CVT.

123. A method as defined in claim 122, further comprising enabling the driver to disengage the coupling via a control.

124. A method as defined in claim 121, wherein the earth working vehicle has a PTO in driven relationship with the internal combustion engine.
